(19) United States
(12) Patent Application Publication
(10) Pub. No.: US 2026/0066939 A1
(43) Pub. Date: Mar. 5, 2026

(54) RADIO FREQUENCY CIRCUIT

(71) Applicant: Murata Manufacturing Co., Ltd., Nagaokakyo-shi (JP)

(72) Inventor: Morio TAKEUCHI, Nagaokakyo-shi (JP)

(73) Assignee: Murata Manufacturing Co., Ltd., Nagaokakyo-shi (JP)

(21) Appl. No.: 19/382,447

(22) Filed: Nov. 7, 2025

Related U.S. Application Data
(63) Continuation of application No. PCT/JP2024/015077, filed on Apr. 16, 2024.

(30) Foreign Application Priority Data
Jun. 1, 2023 (JP) 2023-090983

(51) Int. Cl. H04B 1/40

(52) U.S. Cl. CPC H04B 1/40

(57) ABSTRACT

A radio frequency circuit includes: an antenna connection terminal; an antenna connection terminal; a first power amplifier; a second power amplifier; a first filter in a first signal path between the antenna connection terminal and the first power amplifier and having a passband including a transmission band of a first band; a second filter in a second signal path between the antenna connection terminal and the second power amplifier and having a passband including a transmission band of a second band; and a switch configured to selectively couple an output of the power amplifier and one of the first signal path and the second signal path.

### CROSS-REFERENCE TO RELATED APPLICATIONS

The present application is a bypass continuation application of international application No. PCT/JP2024/015077, filed Apr. 16, 2024, which claims priority to Japanese patent application JP 2023-090983, filed Jun. 1, 2023, the entire contents of each of which being incorporated herein by reference.

### TECHNICAL FIELD

The present disclosure relates to a radio frequency circuit.

### BACKGROUND ART

In mobile communication devices such as a mobile phone, multi-band technology is advancing, and a radio frequency circuit capable of transmitting a plurality of radio frequency signals simultaneously is required. For example, in a communication device described in Patent Document 1, in order to be adaptable to MIMO (Multiple-Input and Multiple-Output), which realizes multipath propagation using a plurality of antennas, a main module and a MIMO module are used to realize uplink (UL) MIMO.

Further, in mobile communication devices such as a mobile phone, the application of high power classes (for example, power classes 2, 1.5, 1, and the like), which allow higher maximum output power than conventional classes, is being promoted for specific frequency bands.

### CITATION LIST

### Patent Document

Patent Document: 1 U.S. Patent Application Publication No. 2015/0133067

### SUMMARY

### Technical Problems

However, in conventional technologies, there is a concern that the circuit scale of the radio frequency circuit will increase when the radio frequency circuit is rendered capable of dealing with simultaneous transmission of a plurality of radio frequency signals in a frequency band to which a high power class can be applied.

Therefore, the present disclosure provides a radio frequency circuit that can deal with simultaneous transmission of a plurality of radio frequency signals in a frequency band to which a high power class can be applied, and can suppress the increase of the circuit scale.

### Solutions to Problems

A radio frequency circuit according to an aspect of the present disclosure includes: a first antenna connection terminal; a second antenna connection terminal; a first power amplifier; a second power amplifier; a first filter connected between the first antenna connection terminal and the first power amplifier and having a passband including a transmission band of a first band; a second filter connected between the second antenna connection terminal and the second power amplifier and having a passband including a transmission band of a second band; and a first switch capable of switching a connection between the first power amplifier and the first filter and a connection between the first power amplifier and the second filter.

A radio frequency circuit according to another aspect of the present disclosure includes: a first antenna connection terminal; a second antenna connection terminal; a first power amplifier; a second power amplifier; a first filter connected between the first antenna connection terminal and the first power amplifier and having a passband including a transmission band of a predetermined band; a second filter connected between the second antenna connection terminal and the second power amplifier and having a passband including a transmission band of the predetermined band; and a first switch capable of switching a connection between the first filter and the first antenna connection terminal and a connection between the first filter and the second antenna connection terminal.

A radio frequency circuit according to yet another aspect of the present disclosure includes: a first antenna connection terminal; a second antenna connection terminal; a first power amplifier; a second power amplifier; a first filter connected between the first antenna connection terminal and the first power amplifier and having a passband including a transmission band of a predetermined band; a second filter connected between the second antenna connection terminal and the second power amplifier and having a passband including a transmission band of the predetermined band; a combiner that includes a first input terminal, a second input terminal, and an output terminal; a first switch capable of switching a connection between the first filter and the first antenna connection terminal and a connection between the first filter and the first input terminal of the combiner; a second switch capable of switching a connection between the second filter and the second antenna connection terminal and a connection between the second filter and the second input terminal of the combiner; and a third switch capable of switching a connection between the first antenna connection terminal and the first switch, a connection between the second antenna connection terminal and the second switch, and a connection between the second antenna connection terminal and the output terminal of the combiner.

### Advantageous Effects

According to the present disclosure, it is possible to deal with simultaneous transmission of a plurality of radio frequency signals in a frequency band to which a high power class can be applied, and further, it is possible to suppress the increase of the circuit scale of the radio frequency circuit.

### BRIEF DESCRIPTION OF DRAWINGS

FIG. 1 is a circuit configuration diagram of a communication device according to Embodiment 1.

FIG. 2 is a diagram showing a first communication mode of the communication device according to Embodiment 1.

FIG. 3 is a diagram showing a second communication mode of the communication device according to Embodiment 1.

FIG. 4 is a circuit configuration diagram of a communication device according to a modification of Embodiment 1.

FIG. 5 is a diagram showing a first communication mode of the communication device according to the modification of Embodiment 1.

FIG. 6 is a diagram showing a second communication mode of the communication device according to the modification of Embodiment 1.

FIG. 7 is a diagram showing a third communication mode of the communication device according to the modification of Embodiment 1.

FIG. 8 is a circuit configuration diagram of a communication device according to Embodiment 2.

FIG. 9 is a diagram showing a first communication mode of the communication device according to Embodiment 2.

FIG. 10 is a diagram showing a second communication mode of the communication device according to Embodiment 2.

FIG. 11 is a circuit configuration diagram of a communication device according to a modification of Embodiment 2.

FIG. 12 is a diagram showing a first communication mode of the communication device according to the modification of Embodiment 2.

FIG. 13 is a diagram showing a second communication mode of the communication device according to the modification of Embodiment 2.

FIG. 14 is a circuit configuration diagram of a communication device according to Embodiment 3.

FIG. 15A is a view showing an example of a circuit configuration diagram of a combiner according to Embodiment 3.

FIG. 15B is a view showing another example of a circuit configuration diagram of the combiner according to Embodiment 3.

FIG. 15C is a view showing another example of a circuit configuration diagram of the combiner according to Embodiment 3.

FIG. 16 is a diagram showing a first communication mode of the communication device according to Embodiment 3.

FIG. 17 is a diagram showing a second communication mode of the communication device according to Embodiment 3.

FIG. 18 is a diagram showing a third communication mode of the communication device according to Embodiment 3.

FIG. 19 is a circuit configuration diagram of a communication device according to Embodiment 4.

FIG. 20 is a diagram showing a first communication mode of the communication device according to Embodiment 4.

FIG. 21 is a diagram showing a second communication mode of the communication device according to Embodiment 4.

FIG. 22 is a circuit configuration diagram of a communication device according to another embodiment.

FIG. 23 is a circuit configuration diagram of a communication device according to another embodiment.

### DESCRIPTION OF EMBODIMENTS

Embodiments of the present disclosure will be described in detail below with reference to the drawings. Note that all the embodiments described below are comprehensive or specific examples. The numerical values, shapes, materials, components, arrangement of components, connection forms and the like shown in the following embodiments are examples and are not intended to limit the present disclosure.

It should be noted that each drawing is schematic with emphasis, omissions, or proportions adjusted as appropriate to illustrate the present disclosure, and is not necessarily strictly illustrative, and may differ from actual shapes, positional relationships, and proportions. In each drawing, substantially identical components are denoted by the same reference signs, and duplicate descriptions may be omitted or simplified.

In circuit configurations of the present disclosure, the term “connected” includes not only the case of being directly connected by connection terminals and/or wiring conductors, but also the case of being electrically connected with another circuit element interposed in between. The expression “C is connected between A and B” means that one end of C is connected to A and the other end of C is connected to B, and that C is connected in series to a path connecting A and B. Furthermore, a component described as being connected “between” two other components is understood to be located in a signal path that can be formed between those two components, which may include direct, indirect, or switchably-selectable connections. The term “terminal” means a point at which a conductor inside an element terminates. Note that when the impedance of a conductor between elements is sufficiently low, the terminal can be interpreted not only as a single point but also as any point on the conductor between elements or as the entire conductor. A “signal path” refers to a route through which a radio frequency signal propagates between specified points in the circuit. Such a path may include one or more components, conductors, and switchable connections.

The term “the passband of a filter” means a portion of a frequency spectrum transmitted by the filter, and is defined as a frequency band in which the output power does not attenuate by 3 dB or more from the maximum output power. Therefore, the high end and low end of the passband of a band pass filter are specified as a higher frequency and a lower frequency of two points at which the output power attenuates by 3 dB from the maximum output power.

### Embodiment 1

Embodiment 1 will be described below. A communication device 5 according to the present embodiment can be used to provide wireless connection. For example, the communication device 5 can be mounted on UE (user equipment) in a cellular network (also called a mobile network), in which examples of the UE include a mobile phone, a smartphone, a tablet computer, and a wearable device. In another example, the communication device 5 can be mounted to provide wireless connection to an IoT (Internet of Things) sensor device, a medical/healthcare device, a car, a UAV (unmanned aerial vehicle) (so-called drone), or an AGV (automated guided vehicle). In yet another example, the communication device 5 can be mounted to provide wireless connection at a wireless access point or a wireless hotspot.

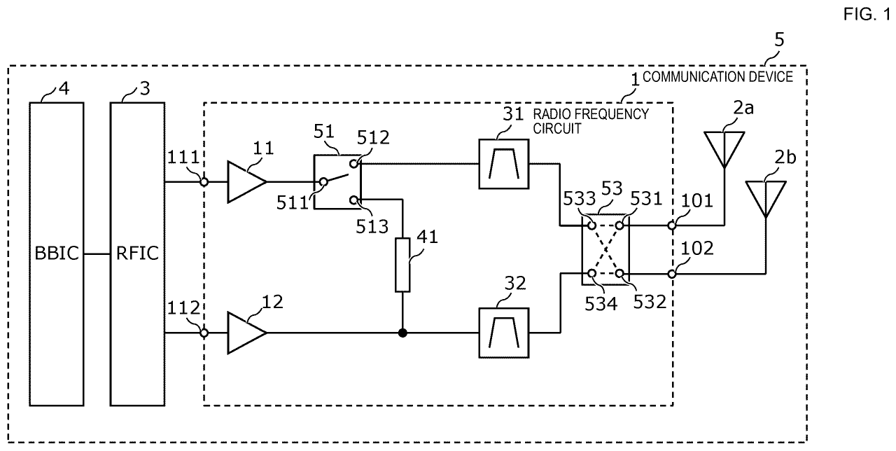

The circuit configuration of the communication device 5 and a radio frequency circuit 1 according to the present embodiment will be described with reference to FIG. 1. FIG. 1 is the circuit configuration diagram of the communication device 5 according to the present embodiment.

FIG. 1 shows an exemplary circuit configuration, and the communication device 5 and the radio frequency circuit 1 may be mounted using any of a wide variety of circuit mounting and circuit techniques. Therefore, the descriptions of the communication device 5 and the radio frequency circuit 1 provided below should not be interpreted in a limited manner.

### [1.1 Circuit Configuration of Communication Device 5]

First, the circuit configuration of the communication device 5 according to the present embodiment will be described with reference to FIG. 1. The communication device 5 is mounted on UE, and includes the radio frequency circuit 1, antennas 2a and 2b, an RFIC (Radio Frequency Integrated Circuit) 3, and a BBIC (Baseband Integrated Circuit) 4.

The radio frequency circuit 1 can transmit radio frequency signals between the antennas 2a and 2b and the RFIC 3. The circuit configuration of the radio frequency circuit 1 will be described later.

The antennas 2a and 2b are connected to antenna connection terminals 101 and 102 of the radio frequency circuit 1, respectively. The antennas 2a and 2b can receive the radio frequency signals from the radio frequency circuit 1 and output the received signals to the outside of the communication device 5. Further, the antennas 2a and 2b may receive radio frequency signals from the outside of the communication device 5 and output the received signals to the radio frequency circuit 1. Note that the antenna 2a and/or antenna 2b does not have to be included in the communication device 5. Also, the communication device 5 may further include one or more antennas in addition to the antennas 2a and 2b.

The RFIC 3 is an example of a signal processing circuit that processes radio frequency signals. Specifically, the RFIC 3 performs signal processing on a transmission signal inputted from the BBIC 4 by up-conversion or the like, and outputs a radio frequency transmission signal generated by performing the signal processing to the radio frequency circuit 1. Further, the RFIC 3 may perform signal processing on a radio frequency reception signal inputted via the radio frequency circuit 1 by down-conversion or the like, and output a reception signal generated by performing the signal processing to the BBIC 4. The RFIC 3 has a control unit for controlling switches, power amplifiers, and the like of the radio frequency circuit 1. Note that part or all of the functions of the control unit of the RFIC 3 may be configured outside of the RFIC 3, for example, in the BBIC 4 or the radio frequency circuit 1.

The BBIC 4 is a baseband signal processing circuit that processes signals using an intermediate frequency band lower in frequency than the radio frequency signals to be transmitted by the radio frequency circuit 1. For example, image signals for image display and/or audio signals for communication via a speaker are used as the signals to be processed by the BBIC 4. Note that the BBIC 4 does not have to be included in the communication device 5.

### [1.2 Circuit Configuration of Radio Frequency Circuit 1]

Next, the circuit configuration of the radio frequency circuit 1 according to the present embodiment will be described with reference to FIG. 1. The radio frequency circuit 1 includes power amplifiers 11 and 12, filters 31 and 32, a phase shifter 41, switches 51 and 53, the antenna connection terminals 101 and 102, and radio frequency input terminals 111 and 112.

The antenna connection terminals 101 and 102 are examples of a first antenna connection terminal and a second antenna connection terminal, and are external connection terminals of the radio frequency circuit 1. Specifically, the antenna connection terminal 101 is connected, outside the radio frequency circuit 1, to the antenna 2a, and is connected, inside the radio frequency circuit 1, to the switch 53. The antenna connection terminal 102 is connected, outside the radio frequency circuit 1, to the antenna 2b, and is connected, inside the radio frequency circuit 1, to the switch 53. Thus, the radio frequency circuit 1 can supply transmission signals to the antennas 2a and 2b via the antenna connection terminals 101 and 102.

Each of the radio frequency input terminals 111 and 112 is an external connection terminal of the radio frequency circuit 1. Specifically, the radio frequency input terminal 111 is connected, outside the radio frequency circuit 1, to the RFIC 3, and is connected, inside the radio frequency circuit 1, to the power amplifier 11. The radio frequency input terminal 112 is connected, outside the radio frequency circuit 1, to the RFIC 3, and is connected, inside the radio frequency circuit 1, to the power amplifier 12. Thus, the radio frequency circuit 1 can receive the radio frequency transmission signal from the RFIC 3 via each of the radio frequency input terminals 111 and 112.

The power amplifier 11 is an example of a first power amplifier, and is connected so as to be switchable between the filters 31 and 32. Specifically, the input end of the power amplifier 11 is connected to the radio frequency input terminal 111. The output end of the power amplifier 11 is connected to the filters 31 and 32 with the switch 51 interposed therebetween. The power amplifier 11 can amplify an input signal (i.e., a transmission signal of a band A) from the radio frequency input terminal 111 using the power supplied from a power supply (not shown).

The power amplifier 12 is an example of a second power amplifier, and is connected to the filter 32. Specifically, the input end of the power amplifier 12 is connected to the radio frequency input terminal 112. The output end of the power amplifier 12 is connected to the filter 32. The power amplifier 12 can amplify an input signal (i.e., a transmission signal of the band A) from the radio frequency input terminal 112 using the power supplied from a power supply (not shown).

The power amplifiers 11 and 12 can constitute a Doherty amplifier. The power amplifier 11 is a carrier amplifier of the Doherty amplifier, and the power amplifier 12 is a peak amplifier of the Doherty amplifier.

The Doherty amplifier means an amplifier circuit which achieves high efficiency by using a plurality of amplifiers as carrier amplifiers and peak amplifiers. The carrier amplifier means an amplifier which operates in the Doherty type power amplifier circuit whether the power of the input signal (radio frequency signal) is low or high. The peak amplifier means an amplifier which operates mainly when the power of the input signal is high in the Doherty type power amplifier circuit.

The power amplifiers 11 and 12 can be composed of HBT (Heterojunction Bipolar Transistor), and can be manufactured using a semiconductor material. For example, silicon germanium (SiGe) or gallium arsenide (GaAs) can be used as the semiconductor material. Note that the amplifying transistor of the power amplifiers 11 and 12 is not limited to HBT. For example, the power amplifier 11 and/or the power amplifier 12 may be composed of HEMT (High Electron Mobility Transistor) or MESFET (Metal-Semiconductor Field Effect Transistor). In such a case, gallium nitride (GaN) or silicon carbide (SiC) may be used as the semiconductor material.

The filter 31 is an example of a first filter, and is connected to the antenna connection terminal 101.

Specifically, one end of the filter 31 is connected so as to be switchable between the antenna connection terminals 101 and 102 with the switch 53 interposed therebetween, and the other end of the filter 31 is connected to the output end of the power amplifier 11 with the switch 51 interposed therebetween. The filter 31 is a band pass filter having a passband including the transmission band of the band A. In the present embodiment, it is sufficient that the filter 31 has an electric power handling capability corresponding to the maximum output power of a second power class, and the filter 31 does not have to have an electric power handling capability corresponding to the maximum output power of a first power class. Note that the filter 31 is not limited to a band pass filter.

The filter 32 is an example of a second filter, and is connected to the antenna connection terminal 102. Specifically, one end of the filter 32 is connected so as to be switchable between the antenna connection terminals 101 and 102 with the switch 53 interposed therebetween, and the other end of the filter 32 is connected to the output end of the power amplifier 12, and is connected to the output end of the power amplifier 11 with the switch 51 interposed therebetween. The filter 32 is a band pass filter having a passband including the transmission band of a band B. In the present embodiment, the filter 32 has an electric power handling capability corresponding to the maximum output power of the first power class. Note that the filter 32 is not limited to a band pass filter.

A SAW (Surface Acoustic Wave) filter, a BAW (Bulk Acoustic Wave) filter, an LC resonant filter or a dielectric resonant filter, or any combination thereof may be used as each of the filters 31 and 32, but the filters 31 and 32 are not limited to such options.

The bands A and B are examples of a first band and a second band, and are frequency bands for a communication system constructed using RAT (Radio Access Technology). The bands A and B are predefined by a standardization organization or the like (for example, 3GPP (registered trademark) (3rd Generation Partnership Project) and IEEE (Institute of Electrical and Electronics Engineers), and the like). Examples of the communication system include a 5GNR (5th Generation New Radio) system, an LTE (Long Term Evolution) system, and a WLAN (Wireless Local Area Network) system.

Frequency bands to which a plurality of power classes, including the first power class and the second power class, can be applied can be used as the bands A and B. Note that, in the present embodiment, the band A may be a frequency band to which the first power class cannot be applied. For example, a combination of Band1 for LTE or n1 for 5GNR and Band3 for LTE or n3 for 5GNR can be used as a combination of the bands A and B. Further, a combination of Band40 for LTE or n40 for 5GNR and Band41 for LTE or n41 for 5GNR may be used as a combination of the bands A and B. Note that the combination of the bands A and B is not limited to the combinations described above. For example, the bands A and B may be the same frequency band, in which case they may be referred to collectively or individually as “a predetermined band”.

The power class is a classification of the output power of the UE defined by the maximum output power; the smaller the power class value, the higher the allowable output power. For example, in 3GPP, the maximum output power of power class 1 is defined as 31 dBm, the maximum output power of power class 1.5 is defined as 29 dBm, the maximum output power of power class 2 is defined as 26 dBm, the maximum output power of power class 3 is defined as 23 dBm, and the maximum output power of power class 5 is defined as 20 dBm.

The maximum output power is defined by the maximum output power at the antenna end. The maximum output power of the UE is measured by a method defined by 3GPP or the like. For example, in FIG. 1, the maximum output power is measured by measuring the radiated power at the antennas 2a and 2b. Note that, instead of measuring the radiated power, the maximum output power of the antennas 2a and 2b can be measured by providing a terminal near the antennas 2a and 2b and connecting a measuring device (for example, a spectrum analyzer) to the terminal.

The first power class is a power class in which a higher maximum output power than the second power class is allowed. For example, power class 2 can be used as the first power class, and power class 3 can be used as the second power class. Note that the combination of the first power class and the second power class is not limited to power classes 2 and 3.

The phase shifter 41 is connected between a terminal 513 of the switch 51 and the filter 32. Specifically, one end of the phase shifter 41 is connected to a path between the filter 32 and the power amplifier 12, and the other end of the phase shifter 41 is connected to the terminal 513 of the switch 51. The phase shifter 41 can shift the phase of the radio frequency signal. Specifically, the phase shifter 41 can shift the phase of the transmission signal of the band B amplified by the power amplifier 11 by −90 degrees (i.e., can delay the phase of the transmission signal of the band B amplified by the power amplifier 11 by 90 degrees). Further, the phase shifter 41 can rotate the load impedance by 180 degrees on a Smith chart, and is sometimes called an impedance converter.

A ¼ wavelength transmission line can be used as the phase shifter 41. The phase shifter 41 may include a capacitor and/or an inductor. Thus, the phase shifter 41 can shorten the length of the transmission line.

The switch 51 is an example of a first switch, and includes terminals 511 and 512, and the terminal 513. The terminal 511 is an example of a first common terminal, and is connected to the output end of the power amplifier 11. The terminal 512 is an example of a first selection terminal, and is connected to the other end of the filter 31. The terminal 513 is an example of a second selection terminal, and is connected to the other end of the phase shifter 41.

In such a connection configuration, the switch 51 can exclusively connect the terminal 511 to the terminals 512 or 513 based on a control signal from the RFIC 3, for example. In other words, the switch 51 can switch the connection between the power amplifier 11 and the filter 31 and the connection between the power amplifier 11 and the filter 32. The switch 51 is composed of, for example, a SPDT (Single-Pole Double-Throw) type switch circuit.

The switch 53 is an example of a third switch, and includes terminals 531 to 534. The terminal 531 is an example of a third common terminal, and is connected to the antenna connection terminal 101. The terminal 532 is an example of a fourth common terminal, and is connected to the antenna connection terminal 102. The terminal 533 is an example of a fifth selection terminal, and is connected to one end of the filter 31. The terminal 534 is an example of a sixth selection terminal, and is connected to one end of the filter 32.

In such a connection configuration, the switch 53 can exclusively connect the terminals 531 or 532 to the terminals 533 and 534 based on a control signal from the RFIC 3, for example. The switch 53 is composed of, for example, a DPDT (Double-Pole Double-Throw) type switch circuit.

Note that the switch 53 does not have to be included in the radio frequency circuit 1. In such a case, one end of the filter 31 may be directly connected to the antenna connection terminal 101, and one end of the filter 32 may be directly connected to the antenna connection terminal 102.

### [1.3 Communication Mode of Radio Frequency Circuit 1]

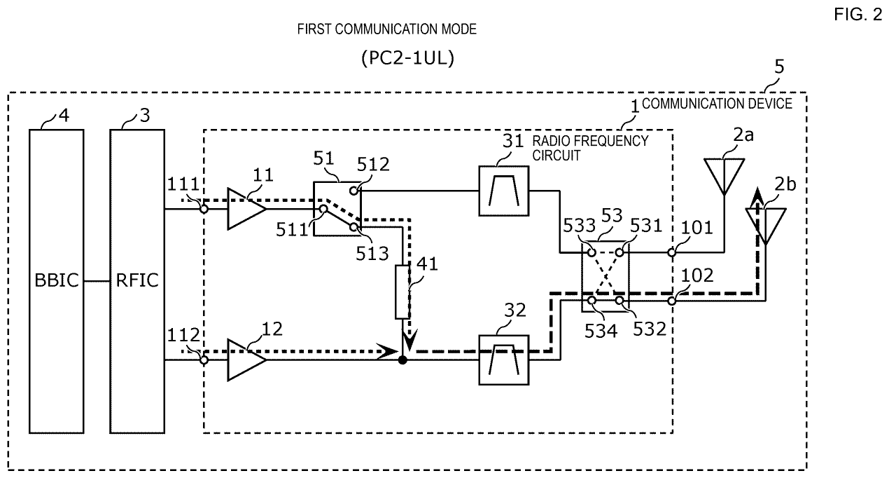

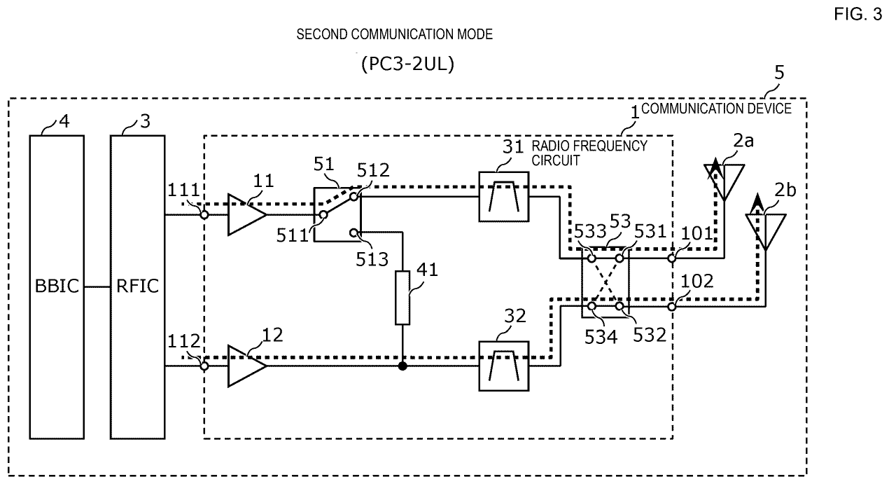

Next, a plurality of communication modes of the radio frequency circuit 1 will be described with reference to FIGS. 2 and 3. In the drawings showing the communication modes, a thick dashed arrow indicates a path of a transmission signal having a power corresponding to the first power class, and a thin dashed arrow indicates a path of a transmission signal having a power corresponding to the second power class.

First, a first communication mode (PC2-1UL) of the radio frequency circuit 1 will be described with reference to FIG. 2. FIG. 2 is a diagram showing the first communication mode of the radio frequency circuit 1 according to the present embodiment.

In the first communication mode, the radio frequency input terminals 111 and 112 receive two identical transmission signals of the band B from the RFIC 3, in which the two identical transmission signals have a phase difference of 90 degrees from each other. At this time, the switch 51 connects the terminal 511 to the terminal 513, and the switch 53 connects the terminal 532 to the terminal 534. Conversely, the switch 51 does not connect the terminal 511 to the terminal 512, and the switch 53 does not connect the terminal 532 to the terminal 533.

Thus, the transmission signal of the band B received from the RFIC 3 via the radio frequency input terminal 111 is transmitted to the filter 32 via the power amplifier 11, the switch 51, and the phase shifter 41. Further, the transmission signal of the band B received from the RFIC 3 via the radio frequency input terminal 112 is transmitted to the filter 32 via the power amplifier 12. Further, the two transmission signals of the band B are combined into one signal and transmitted to the antenna 2b via the filter 32, the switch 53, and the antenna connection terminal 102. As a result, the communication device 5 can transmit one transmission signal (for example, uplink signal) of the band B to the outside in the first power class (for example, power class 2).

Next, a second communication mode (PC3-2UL) of the radio frequency circuit 1 will be described with reference to FIG. 3. FIG. 3 is a diagram showing the second communication mode of the radio frequency circuit 1 according to the present embodiment.

In the second communication mode, the radio frequency input terminals 111 and 112 receive the transmission signals of the bands A and B from the RFIC 3, respectively. At this time, the switch 51 connects the terminal 511 to the terminal 512, and the switch 53 connects the terminal 531 to the terminal 533 and connects the terminal 532 to the terminal 534. Conversely, the switch 51 does not connect the terminal 511 to the terminal 513, and the switch 53 does not connect the terminal 531 to the terminal 534 and does not connect the terminal 532 to the terminal 533.

Thus, the transmission signal of the band A received from the RFIC 3 via the radio frequency input terminal 111 is transmitted to the antenna 2a via the power amplifier 11, the switch 51, the filter 31, the switch 53, and the antenna connection terminal 101. On the other hand, the transmission signal of the band B received from the RFIC 3 via the radio frequency input terminal 112 is transmitted to the antenna 2b via the power amplifier 12, the filter 32, the switch 53, and the antenna connection terminal 102. As a result, the communication device 5 can simultaneously transmit two transmission signals (for example, uplink signals) of the bands A and B to the outside in the second power class (for example, power class 3).

### [1.4 Effects]

As described above, the radio frequency circuit 1 according to the present embodiment includes: the antenna connection terminals 101 and 102; the power amplifiers 11 and 12; the filter 31 connected between the antenna connection terminal 101 and the power amplifier 11 and having the passband including the transmission band of the band A; the filter 32 connected between the antenna connection terminal 102 and the power amplifier 12 and having the passband including the transmission band of the band B; and the switch 51 capable of switching the connection between the power amplifier 11 and the filter 31 and the connection between the power amplifier 11 and the filter 32.

With such a configuration, the radio frequency circuit 1 can use the switch 51 to connect the two power amplifiers 11 and 12 to the one antenna connection terminal 102 with the filter 32 interposed therebetween. Therefore, since the two radio frequency signals amplified by the power amplifiers 11 and 12 can be combined, the amplification of radio frequency signals corresponding to the high power class can be realized while suppressing the increase in the maximum output power of each of the power amplifiers 11 and 12. Further, the radio frequency circuit 1 can use the switch 51 to individually connect the two power amplifiers 11 and 12 to the two antenna connection terminals 101 and 102 with the two filters 31 and 32 interposed therebetween, respectively. Therefore, the radio frequency circuit 1 can simultaneously transmit the two radio frequency signals of the bands A and B in a low power class. In other words, in the radio frequency circuit 1 adaptable to the high power class, it is possible to deal with simultaneous transmission of a plurality of radio frequency signals without increasing the number of power amplifiers. In summary, the radio frequency circuit 1 can deal with simultaneous transmission of a plurality of radio frequency signals in a frequency band to which the high power class can be applied, and further, can suppress the increase of the circuit scale of the radio frequency circuit 1.

Further, for example, the radio frequency circuit 1 according to the present embodiment may further include the phase shifter 41 connected between the switch 51 and the filter 32. The power amplifiers 11 and 12 may constitute a Doherty amplifier. The power amplifier 11 may be a carrier amplifier. The power amplifier 12 may be a peak amplifier.

With such a configuration, the radio frequency circuit 1 can realize the improvement of power efficiency by the Doherty amplifier.

Further, for example, in the radio frequency circuit 1 according to the present embodiment, the switch 51 may include the terminal 511 connected to the power amplifier 11, the terminal 512 connected to the filter 31, and the terminal 513 connected to the filter 32. In a first communication mode in which one signal of the band B is transmitted in a first power class defined by a first maximum output power, the switch 51 may be configured to connect the terminal 511 to the terminal 513. In a second communication mode in which two signals of the bands A and B are simultaneously transmitted in a second power class defined by a second maximum output power lower than the first maximum output power, the switch 51 may be configured to connect the terminal 511 to the terminal 512.

With such a configuration, the radio frequency circuit 1 can be adapted to the high power class of the band B in the first communication mode, and can deal with simultaneous transmission of two signals of the bands A and B in the second communication mode.

Further, for example, the radio frequency circuit 1 according to the present embodiment may further include a switch 53 that includes the terminal 531 connected to the antenna connection terminal 101, the terminal 532 connected to the antenna connection terminal 102, the terminal 533 connected to the filter 31, and the terminal 534 connected to the filter 32.

With such a configuration, antenna swapping can be realized by the switch 53.

### Modification of Embodiment 1

Next, a modification of Embodiment 1 will be described. The present modification is mainly different from Embodiment 1 in that the filter 32 is also connected to the switches in the same manner as the filter 31. The present modification will be described below with reference to the drawings, focusing on the points different from Embodiment 1.

The circuit configuration of a communication device 5A according to the present modification is the same as the circuit configuration of the communication device 5 according to Embodiment 1 except that the communication device 5A includes a radio frequency circuit 1A instead of the radio frequency circuit 1; therefore, the circuit configuration of the radio frequency circuit 1A will be described.

### [1.5 Circuit Configuration of Radio Frequency Circuit 1A]

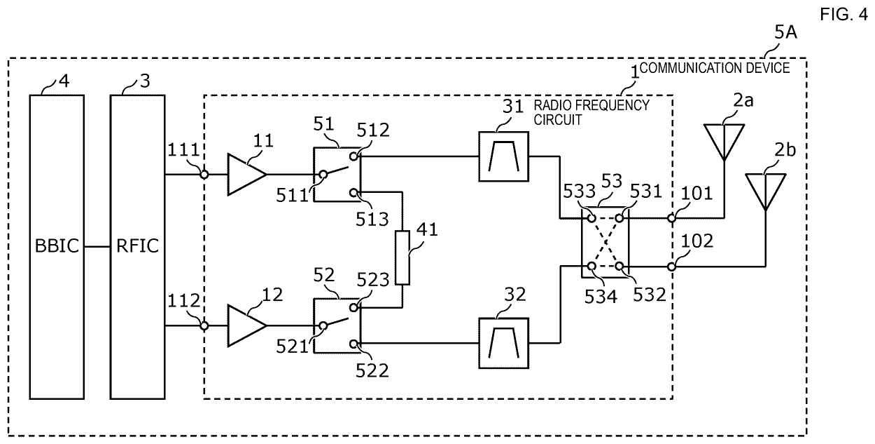

The circuit configuration of the radio frequency circuit 1A will be described with reference to FIG. 4. FIG. 4 is a circuit configuration diagram of the communication device 5A according to the present modification.

FIG. 4 shows an exemplary circuit configuration, and the communication device 5A and the radio frequency circuit 1A may be mounted using any of a wide variety of circuit mounting and circuit techniques. Therefore, the description of the radio frequency circuit 1A provided below should not be interpreted in a limited manner.

The radio frequency circuit 1A includes power amplifiers 11 and 12, filters 31 and 32, a phase shifter 41, switches 51 to 53, antenna connection terminals 101 and 102, and radio frequency input terminals 111 and 112.

In the present modification, the filter 31 has an electric power handling capability corresponding to the maximum output power of the first power class.

The switch 52 is an example of the second switch, and includes terminals 521 to 523. The terminal 521 is an example of a second common terminal, and is connected to the output end of the power amplifier 12. The terminal 522 is an example of a third selection terminal, and is connected to the other end of the filter 32. The terminal 523 is an example of a fourth selection terminal, and is connected to one end of the phase shifter 41.

In such a connection configuration, the switch 52 can connect the terminal 521 to one or both of the terminals 522 and 523 based on a control signal from the RFIC 3, for example. The switch 52 is composed of, for example, a multi-connection type switch circuit.

### [1.6 Communication Mode of Radio Frequency Circuit 1A]

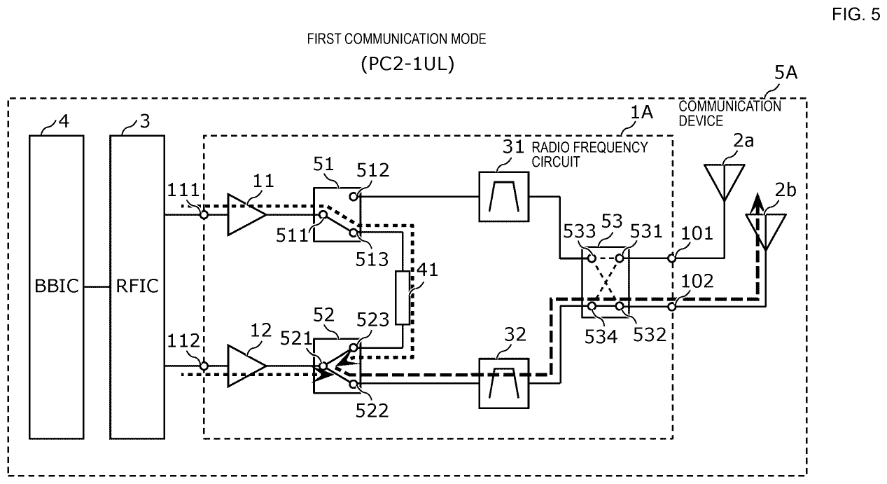

Next, a plurality of communication modes of the radio frequency circuit 1A will be described with reference to FIGS. 5 to 7. First, a first communication mode (PC2-1UL) of the radio frequency Circuit 1A will be described with reference to FIG. 5. FIG. 5 is a diagram showing the first communication mode of the radio frequency circuit 1A according to the present modification.

In the first communication mode, the radio frequency input terminals 111 and 112 receive two identical transmission signals of the band B from the RFIC 3, in which the two identical transmission signals have a phase difference of 90 degrees from each other. At this time, the switch 51 connects the terminal 511 to the terminal 513, the switch 52 connects the terminal 521 to the terminals 522 and 523, and the switch 53 connects the terminal 532 to the terminal 534. Conversely, the switch 51 does not connect the terminal 511 to the terminal 512, and the switch 53 does not connect the terminal 532 to the terminal 533.

Thus, the transmission signal of the band B received from the RFIC 3 via the radio frequency input terminal 111 is transmitted to the terminal 523 of the switch 52 via the power amplifier 11, the switch 51, and the phase shifter 41. Further, the transmission signal of the band B received from the RFIC 3 via the radio frequency input terminal 112 is transmitted to the terminal 521 of the switch 52 via the power amplifier 12. Further, the two transmission signals of the band B are combined into one signal by the switch 52, and transmitted to the antenna 2b via the filter 32, the switch 53, and the antenna connection terminal 102. As a result, the communication device 5A can transmit one transmission signal (for example, uplink signal) of the band B to the outside in the first power class (for example, power class 2).

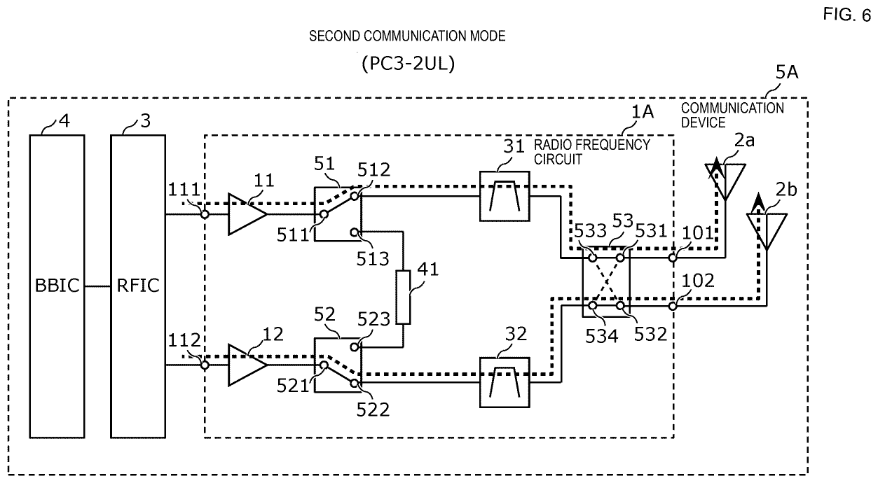

Next, a second communication mode (PC3-2UL) of the radio frequency circuit 1A will be described with reference to FIG. 6. FIG. 6 is a diagram showing the second communication mode of the radio frequency circuit 1A according to the present modification.

In the second communication mode, the radio frequency input terminals 111 and 112 receive the transmission signals of the bands A and B from the RFIC 3, respectively. At this time, the switch 51 connects the terminal 511 to the terminal 512, the switch 52 connects the terminal 521 to the terminal 522, and the switch 53 connects the terminal 531 to the terminal 533 and connects the terminal 532 to the terminal 534. Conversely, the switch 51 does not connect the terminal 511 to the terminal 513, the switch 52 does not connect the terminal 521 to the terminal 523, and the switch 53 does not connect the terminal 531 to the terminal 534 and does not connect terminal 532 to the terminal 533.

Thus, the transmission signal of the band A received from the RFIC 3 via the radio frequency input terminal 111 is transmitted to the antenna 2a via the power amplifier 11, the switch 51, the filter 31, the switch 53, and the antenna connection terminal 101. On the other hand, the transmission signal of the band B received from the RFIC 3 via the radio frequency input terminal 112 is transmitted to the antenna 2b via the power amplifier 12, the switch 52, the filter 32, the switch 53, and the antenna connection terminal 102. As a result, the communication device 5A can simultaneously transmit two transmission signals (for example, uplink signals) of the bands A and B to the outside in the second power class (for example, power class 3).

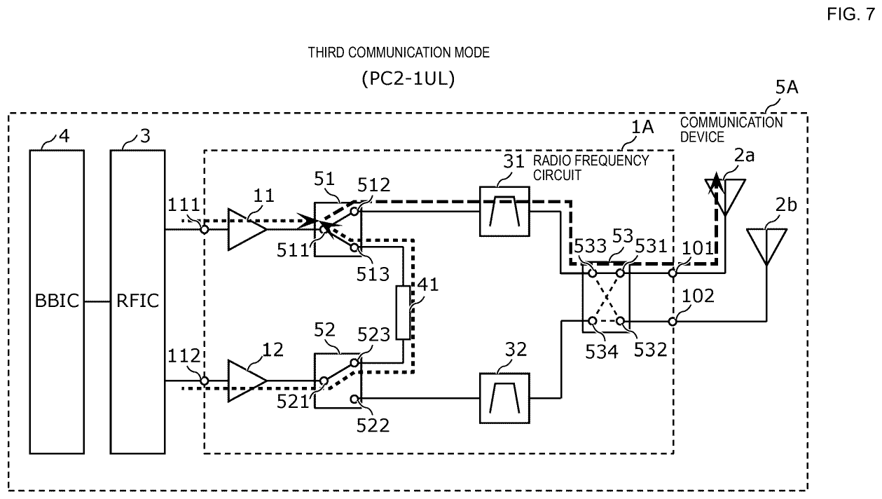

Next, a third communication mode (PC2-1UL) of the radio frequency circuit 1A will be described with reference to FIG. 7. FIG. 7 is a diagram showing the third communication mode of the radio frequency circuit 1A according to the present modification.

In the third communication mode, the radio frequency input terminals 111 and 112 receive two identical transmission signals of the band A from the RFIC 3, in which the two identical transmission signals have a phase difference of 90 degrees from each other. At this time, the switch 51 connects the terminal 511 to the terminals 512 and 513, the switch 52 connects the terminal 521 to the terminal 523, and the switch 53 connects the terminal 531 to the terminal 533. Conversely, the switch 52 does not connect the terminal 521 to the terminal 522, and the switch 53 does not connect the terminal 531 to the terminal 534.

Thus, the transmission signal of the band A received from the RFIC 3 via the radio frequency input terminal 111 is transmitted to the terminal 511 of the switch 51 via the power amplifier 11. Further, the transmission signal of the band A received from the RFIC 3 via the radio frequency input terminal 112 is transmitted to the terminal 513 of the switch 51 via the power amplifier 12, the switch 52, and the phase shifter 41. Further, the two transmission signals of the band A are combined into one signal by the switch 51, and transmitted to the antenna 2a via the filter 31, the switch 53, and the antenna connection terminal 101. As a result, the communication device 5A can transmit one transmission signal (for example, uplink signal) of the band A to the outside in the first power class (for example, power class 2).

### [1.7 Effects]

As described above, the radio frequency circuit 1A according to the present modification may further include the switch 52 that includes the terminal 521 connected to the power amplifier 12, the terminal 522 connected to the filter 32, and the terminal 523 connected to the terminal 513 of the switch 51. The phase shifter 41 may be connected between the terminal 513 of the switch 51 and the terminal 523 of the switch 52.

With such a configuration, the radio frequency circuit 1A can disconnect the phase shifter 41 from the transmission path from the power amplifier 12 to the antenna connection terminal 102 by switching the switch 52, so that mismatching loss caused by the phase shifter 41 can be suppressed.

Further, for example, in the radio frequency circuit 1A according to the present modification, in the first communication mode in which one signal of the band B is transmitted in the first power class defined by the first maximum output power, the switch 51 may be configured to connect the terminal 511 to the terminal 513, and the switch 52 may be configured to connect the terminal 521 to the terminals 522 and 523. In the second communication mode in which two signals of the bands A and B are simultaneously transmitted in the second power class defined by the second maximum output power lower than the first maximum output power, the switch 51 may be configured to connect the terminal 511 to the terminal 512, and the switch 52 may be configured to connect the terminal 521 to the terminal 522. In a third communication mode in which one signal of the band A is transmitted in the first power class, the switch 51 may be configured to connect the terminal 511 to the terminals 512 and 513, and the switch 52 may be configured to connect the terminal 521 to the terminal 523.

With such a configuration, the radio frequency circuit 1A can be adapted to the high power class of the band B in the first communication mode, can deal with simultaneous transmission of two signals of the bands A and B in the second communication mode, and can be adapted to the high power class of the band A in the third communication mode.

Further, for example, the radio frequency circuit 1A according to the present modification may further include the switch 53 that includes the terminal 531 connected to the antenna connection terminal 101, the terminal 532 connected to the antenna connection terminal 102, the terminal 533 connected to the filter 31, and the terminal 534 connected to the filter 32.

With such a configuration, the radio frequency circuit 1A can realize antenna swapping by the switch 53.

### Embodiment 2

Next, Embodiment 2 will be described. The present embodiment is mainly different from Embodiment 1 in that the radio frequency circuit is configured so that the radio frequency signals are combined after passing through the filters. The present embodiment will be described below with reference to the drawings, focusing on the points different from Embodiment 1.

The circuit configuration of a communication device 5B according to the present embodiment is the same as the circuit configuration of the communication device 5 according to Embodiment 1 except that the communication device 5B includes a radio frequency circuit 1B instead of the radio frequency circuit 1; therefore, the circuit configuration of the radio frequency circuit 1B will be described.

### [2.1 Circuit Configuration of Radio Frequency Circuit 1B]

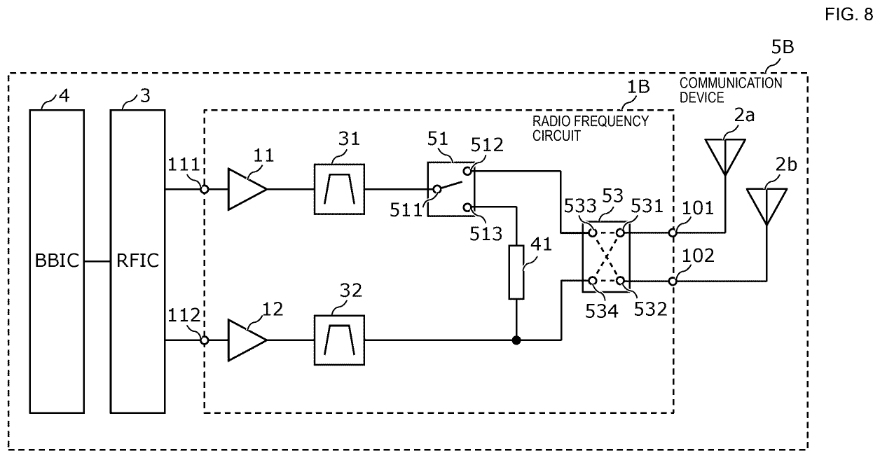

The circuit configuration of the radio frequency circuit 1B will be described with reference to FIG. 8. FIG. 8 is a circuit configuration diagram of the communication device 5B according to the present embodiment.

FIG. 8 shows an exemplary circuit configuration, and the communication device 5B and the radio frequency circuit 1B may be mounted using any of a wide variety of circuit mounting and circuit techniques. Therefore, the description of the radio frequency circuit 1B provided below should not be interpreted in a limited manner.

The radio frequency circuit 1B includes power amplifiers 11 and 12, filters 31 and 32, a phase shifter 41, switches 51 and 53, antenna connection terminals 101 and 102, and radio frequency input terminals 111 and 112.

The power amplifier 11 is an example of the first power amplifier, and is connected to the filter 31. Specifically, the input end of the power amplifier 11 is connected to the radio frequency input terminal 111. The output end of the power amplifier 11 is connected to the filter 31.

The power amplifier 12 is an example of the second power amplifier, and is connected to the filter 32. Specifically, the input end of the power amplifier 12 is connected to the radio frequency input terminal 112. The output end of the power amplifier 12 is connected to the filter 32.

The power amplifiers 11 and 12 can constitute a Doherty amplifier in the same manner as in Embodiment 1. The power amplifier 11 is a carrier amplifier of the Doherty amplifier, and the power amplifier 12 is a peak amplifier of the Doherty amplifier.

The filter 31 is an example of the first filter, and is connected so as to be switchable between the antenna connection terminals 101 and 102. Specifically, one end of the filter 31 is connected so as to be switchable between the antenna connection terminals 101 and 102 with the switches 51 and 53 interposed therebetween, and the other end of the filter 31 is connected to the output end of the power amplifier 11. The filter 31 is a band pass filter having a passband including the transmission band of the band A. In the present embodiment, it is sufficient that the filter 31 has an electric power handling capability corresponding to the maximum output power of the second power class, and the filter 31 does not have to have an electric power handling capability corresponding to the maximum output power of the first power class.

The filter 32 is an example of the second filter, and is connected to the antenna connection terminal 102. Specifically, one end of the filter 32 is connected so as to be switchable between the antenna connection terminals 101 and 102 with the switch 53 interposed therebetween, and the other end of the filter 32 is connected to the output end of the power amplifier 12. In the present embodiment, the filter 32 does not have to have an electric power handling capability corresponding to the maximum output power of the first power class. The filter 32 is a band pass filter having a passband including the transmission band of the band A. In the present embodiment, it is sufficient that the filter 32 has an electric power handling capability corresponding to the maximum output power of the second power class, and the filter 32 does not have to have an electric power handling capability corresponding to the maximum output power of the first power class.

The phase shifter 41 is connected between a terminal 513 of the switch 51 and a terminal 534 of the switch 53. Specifically, one end of the phase shifter 41 is connected to a path between the filter 32 and the switch 53, and the other end of the phase shifter 41 is connected to the terminal 513 of the switch 51. The phase shifter 41 can shift the phase of the radio frequency signal in the same manner as in Embodiment 1. Specifically, the phase shifter 41 can shift the phase of the transmission signal of the band A amplified by the power amplifier 11 by −90 degrees (i.e., can delay the phase of the transmission signal of the band A amplified by the power amplifier 11 by 90 degrees). Further, the phase shifter 41 can rotate the load impedance by 180 degrees on a Smith chart, and is sometimes called an impedance converter.

The switch 51 is an example of the first switch, and includes terminals 511 and 512, and the terminal 513. The terminal 511 is an example of the first common terminal, and is connected to one end of the filter 31. The terminal 512 is an example of the first selection terminal, and is connected to a terminal 533 of the switch 53. The terminal 513 is an example of the second selection terminal, and is connected to the other end of the phase shifter 41.

The switch 53 is an example of the third switch, and includes terminals 531 to 533, and the terminal 534. The terminal 531 is an example of the third common terminal, and is connected to the antenna connection terminal 101. The terminal 532 is an example of the fourth common terminal, and is connected to the antenna connection terminal 102. The terminal 533 is an example of the fifth selection terminal, and is connected to the terminal 512 of the switch 51. The terminal 534 is an example of the sixth selection terminal, and is connected to one end of the filter 32 and one end of the phase shifter 41.

The switch 53 does not have to be included in the radio frequency circuit 1B. In such a case, the terminal 512 of the switch 51 may be directly connected to the antenna connection terminal 101, the terminal 513 of the switch 51 may be connected to the antenna connection terminal 102 with the phase shifter 41 interposed therebetween, and one end of the filter 32 may be directly connected to the antenna connection terminal 102.

### [2.2 Communication Mode of Radio Frequency Circuit 1B]

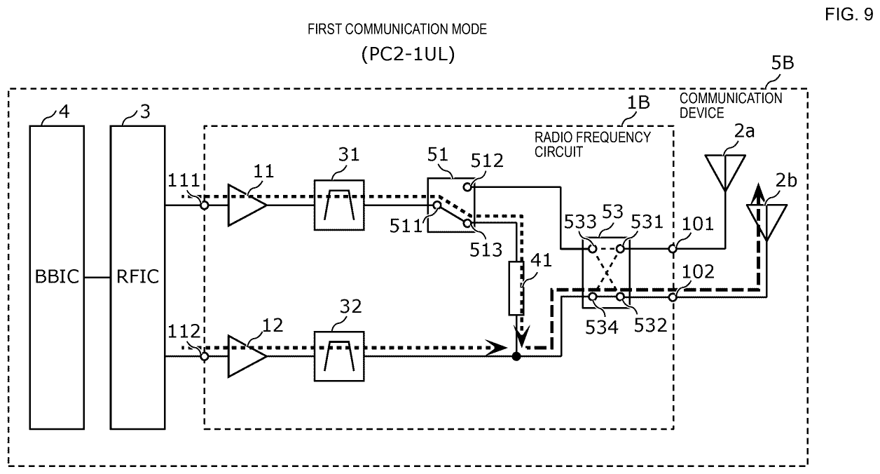

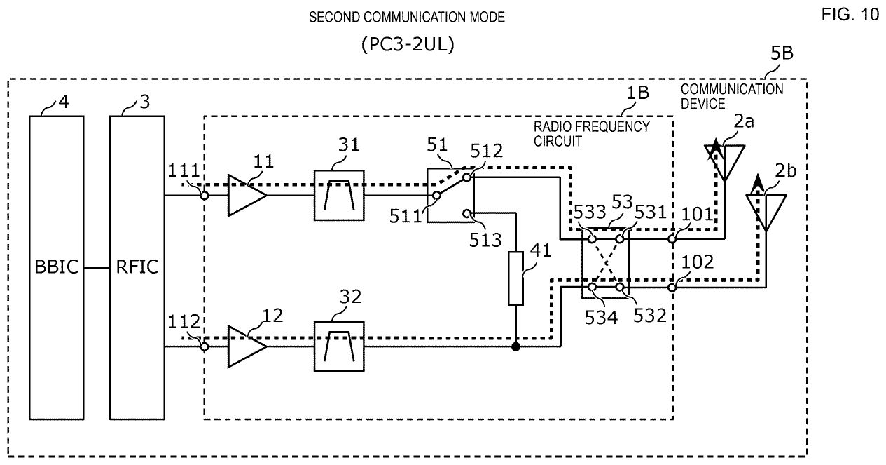

Next, a plurality of communication modes of the radio frequency circuit 1B will be described with reference to FIGS. 9 and 10. First, a first communication mode (PC2-1UL) of the radio frequency circuit 1B will be described with reference to FIG. 9. FIG. 9 is a diagram showing the first communication mode of the radio frequency circuit 1B according to the present embodiment.

In the first communication mode, the radio frequency input terminals 111 and 112 receive two identical transmission signals of the band A from the RFIC 3, in which the two identical transmission signals have a phase difference of 90 degrees from each other. At this time, the switch 51 connects the terminal 511 to the terminal 513, and the switch 53 connects the terminal 532 to the terminal 534. Conversely, the switch 51 does not connect the terminal 511 to the terminal 512, and the switch 53 does not connect the terminal 532 to the terminal 533.

Thus, the transmission signal of the band A received from the RFIC 3 via the radio frequency input terminal 111 is transmitted to the terminal 534 of the switch 53 via the power amplifier 11, the filter 31, the switch 51, and the phase shifter 41. Further, the transmission signal of the band A received from the RFIC 3 via the radio frequency input terminal 112 is transmitted to the terminal 534 of the switch 53 via the power amplifier 12 and the filter 32. Further, the two transmission signals of the band A are combined into one signal and transmitted to the antenna 2b via the switch 53 and the antenna connection terminal 102. As a result, the communication device 5B can transmit one transmission signal (for example, uplink signal) of the band A to the outside in the first power class (for example, power class 2).

Next, a second communication mode (PC3-2UL) of the radio frequency circuit 1B will be described with reference to FIG. 10. FIG. 10 is a diagram showing the second communication mode of the radio frequency circuit 1B according to the present embodiment.

In the second communication mode, the radio frequency input terminals 111 and 112 receive two different transmission signals of the band A from the RFIC 3. At this time, the switch 51 connects the terminal 511 to the terminal 512, and the switch 53 connects the terminal 531 to the terminal 533 and connects the terminal 532 to the terminal 534. Conversely, the switch 51 does not connect the terminal 511 to the terminal 513, and the switch 53 does not connect the terminal 531 to the terminal 534 and does not connect the terminal 532 to the terminal 533.

Thus, the transmission signal of the band A received from the RFIC 3 via the radio frequency input terminal 111 is transmitted to the antenna 2a via the power amplifier 11, the filter 31, the switch 51, the switch 53, and the antenna connection terminal 101. On the other hand, the transmission signal of the band A received from the RFIC 3 via the radio frequency input terminal 112 is transmitted to the antenna 2b via the power amplifier 12, the filter 32, the switch 53, and the antenna connection terminal 102. As a result, the communication device 5B can simultaneously transmit two transmission signals (for example, uplink signals) of the band A to the outside in the second power class (for example, power class 3).

### [2.3 Effects]

As described above, the radio frequency circuit 1B according to the present embodiment includes: the antenna connection terminals 101 and 102; the power amplifiers 11 and 12; the filter 31 connected between the antenna connection terminal 101 and the power amplifier 11 and having the passband including the transmission band of the band A; the filter 32 connected between the antenna connection terminal 102 and the power amplifier 12 and having the passband including the transmission band of the band A; and the switch 51 capable of switching the connection between the filter 31 and the antenna connection terminal 101 and the connection between the filter 31 and the antenna connection terminal 102.

With such a configuration, the radio frequency circuit 1B can use the switch 51 to connect the two power amplifiers 11 and 12 to the one antenna connection terminal 102 with the filters 31 and 32 interposed therebetween, respectively. Therefore, since the two radio frequency signals amplified by the power amplifiers 11 and 12 can be combined, the amplification of radio frequency signals corresponding to the high power class can be realized while suppressing the increase in the maximum output power of each of the power amplifiers 11 and 12. At this time, since the two radio frequency signals amplified by the power amplifiers 11 and 12 are combined after passing through the filters 31 and 32, respectively, it is possible to suppress the increase in the electric power handling capability required for the filters 31 and 32 without necessity to adapt each of the filters 31 and 32 to the high power class. Further, the radio frequency circuit 1B can use the switch 51 to individually connect the two power amplifiers 11 and 12 to the two antenna connection terminals 101 and 102 with the two filters 31 and 32 interposed therebetween, respectively. Therefore, the radio frequency circuit 1B can simultaneously transmit two radio frequency signals of the same band in a low power class. In other words, in the radio frequency circuit 1B adaptable to the high power class, it is possible to deal with simultaneous transmission of a plurality of radio frequency signals without increasing the number of power amplifiers. In summary, the radio frequency circuit 1B can deal with simultaneous transmission of a plurality of radio frequency signals in a frequency band to which the high power class can be applied, and further, can suppress the increase of the circuit scale of the radio frequency circuit 1B.

Further, for example, the radio frequency circuit 1B according to the present embodiment may further include the phase shifter 41 connected between the switch 51 and the antenna connection terminal 102. The power amplifier 11 and the power amplifier 12 may constitute a Doherty amplifier. The power amplifier 11 may be a carrier amplifier. The power amplifier 12 may be a peak amplifier.

With such a configuration, the radio frequency circuit 1B can realize the improvement of power efficiency by the Doherty amplifier.

Further, for example, in the radio frequency circuit 1B according to the present embodiment, the switch 51 may include the terminal 511 connected to the filter 31, the terminal 512 connected to the antenna connection terminal 101, and the terminal 513 connected to the antenna connection terminal 102. In a first communication mode in which one signal of the band A is transmitted in a first power class defined by a first maximum output power, the switch 51 may be configured to connect the terminal 511 to the terminal 513. In a second communication mode in which two signals of the band A are simultaneously transmitted in a second power class defined by a second maximum output power lower than the first maximum output power, the switch 51 may be configured to connect the terminal 511 to the terminal 512.

With such a configuration, the radio frequency circuit 1B can be adapted to the high power class of the band A in the first communication mode, and can deal with simultaneous transmission of two signals of the band A in the second communication mode.

### Modification of Embodiment 2

Next, a modification of Embodiment 2 will be described. The present modification is mainly different from Embodiment 2 in that the filter 32 is also connected to the switches in the same manner as the filter 31. The present modification will be described below with reference to the drawings, focusing on the points different from Embodiment 2.

The circuit configuration of a communication device 5C according to the present modification is the same as the circuit configuration of the communication device 5B according to Embodiment 2 except that the communication device 5C includes a radio frequency circuit 1C instead of the radio frequency circuit 1B; therefore, the circuit configuration of the radio frequency circuit 1C will be described.

### [2.4 Circuit Configuration of the Radio Frequency Circuit 1C]

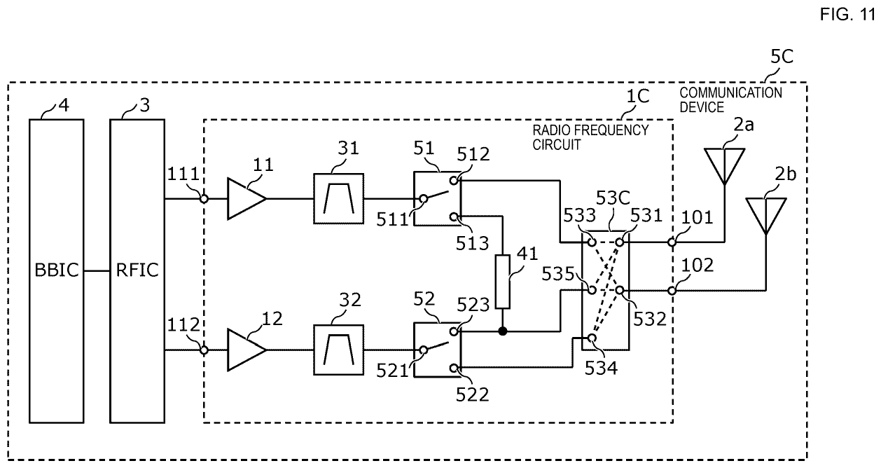

The circuit configuration of the radio frequency circuit 1C will be described with reference to FIG. 11. FIG. 11 is a circuit configuration diagram of the communication device 5C according to the present modification.

FIG. 11 shows an exemplary circuit configuration, and the communication device 5C and the radio frequency circuit 1C may be mounted using any of a wide variety of circuit mounting and circuit techniques. Therefore, the description of the radio frequency circuit 1C provided below should not be interpreted in a limited manner.

The radio frequency circuit 1C includes power amplifiers 11 and 12, filters 31 and 32, a phase shifter 41, switches 51, 52 and 53C, antenna connection terminals 101 and 102, and radio frequency input terminals 111 and 112.

The phase shifter 41 is connected between a terminal 513 of the switch 51 and a terminal 535 of the switch 53C. Specifically, one end of the phase shifter 41 is connected to a path between the filter 32 and the switch 53C, and the other end of the phase shifter 41 is connected to the terminal 513 of the switch 51.

The switch 52 is an example of the second switch, and includes terminals 521 to 523. The terminal 521 is an example of the second common terminal, and is connected to one end of the filter 32. The terminal 522 is an example of the third selection terminal, and is connected so as to be switchable between the antenna connection terminals 101 and 102 with the switch 53C interposed therebetween. The terminal 523 is an example of the fourth selection terminal, and is connected to the terminal 513 of the switch 51 with the phase shifter 41 interposed therebetween, and is further connected to the terminal 535 of the switch 53C.

The switch 53C is an example of the third switch, and includes terminals 531 to 534, and the terminal 535. The terminal 531 is an example of the third common terminal, and is connected to the antenna connection terminal 101. The terminal 532 is an example of the fourth common terminal, and is connected to the antenna connection terminal 102. The terminal 533 is an example of the fifth selection terminal, and is connected to the terminal 512 of the switch 51. The terminal 534 is an example of the sixth selection terminal, and is connected to the terminal 522 of the switch 52. The terminal 535 is an example of a seventh selection terminal, and is connected to the terminal 523 of the switch 52.

In such a connection configuration, the switch 53C can exclusively connect the terminals 531 or 532 to the terminals 533 to 535 based on a control signal from the RFIC 3, for example. The switch 53C is composed of, for example, a DP3T (Double-Pole Triple-Throw) type switch circuit.

### [2.5 Communication Mode of Radio Frequency Circuit 1C]

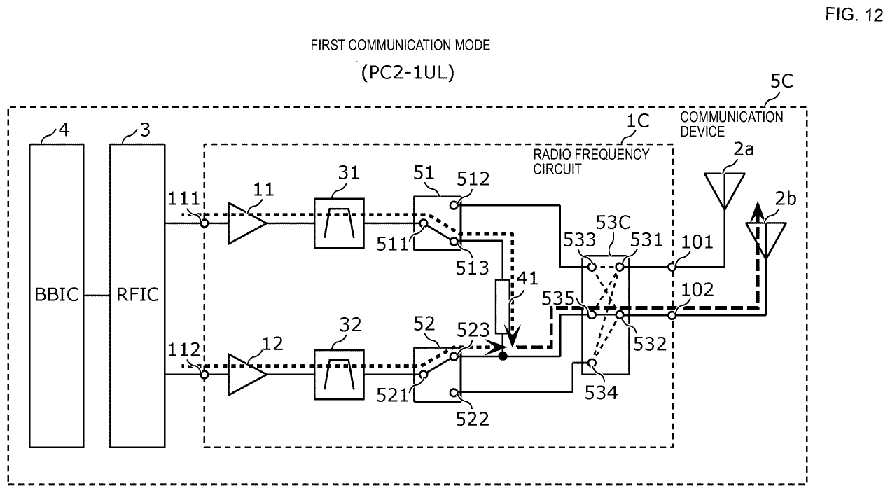

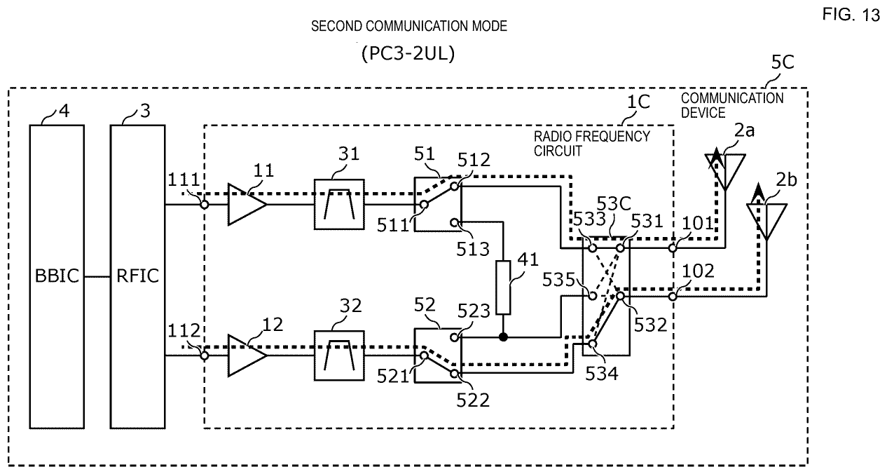

Next, a plurality of communication modes of the radio frequency circuit 1C will be described with reference to FIGS. 12 and 13. First, a first communication mode (PC2-1UL) of the radio frequency circuit 1C will be described with reference to FIG. 12. FIG. 12 is a diagram showing the first communication mode of the radio frequency circuit 1C according to the present modification.

In the first communication mode, the radio frequency input terminals 111 and 112 receive two identical transmission signals of the band A from the RFIC 3, in which the two identical transmission signals have a phase difference of 90 degrees from each other. At this time, the switch 51 connects the terminal 511 to the terminal 513, the switch 52 connects the terminal 521 to the terminal 523, and the switch 53C connects the terminal 532 to the terminal 535. Conversely, the switch 51 does not connect the terminal 511 to the terminal 512, the switch 52 does not connect the terminal 521 to the terminal 522, and the switch 53C does not connect the terminal 532 to the terminals 533 and 534.

Thus, the transmission signal of the band A received from the RFIC 3 via the radio frequency input terminal 111 is transmitted to the terminal 535 of the switch 53C via the power amplifier 11, the filter 31, the switch 51, and the phase shifter 41. Further, the transmission signal of the band A received from the RFIC 3 via the radio frequency input terminal 112 is transmitted to the terminal 535 of the switch 53C via the power amplifier 12, the filter 32, and the switch 52. Further, the two transmission signals of the band A are combined into one signal and transmitted to the antenna 2b via the switch 53C and the antenna connection terminal 102. As a result, the communication device 5C can transmit one transmission signal (for example, uplink signal) of the band A to the outside in the first power class (for example, power class 2).

Next, a second communication mode (PC3-2UL) of the radio frequency circuit 1C will be described with reference to FIG. 13. FIG. 13 is a diagram showing the second communication mode of the radio frequency circuit 1C according to the present modification.

In the second communication mode, the radio frequency input terminals 111 and 112 receive two different transmission signals of the band A from the RFIC 3. At this time, the switch 51 connects the terminal 511 to the terminal 512, the switch 52 connects the terminal 521 to the terminal 522, and the switch 53C connects the terminal 531 to the terminal 533 and connects the terminal 532 to the terminal 534. Conversely, the switch 51 does not connect the terminal 511 to the terminal 513, the switch 52 does not connect the terminal 521 to the terminal 523, and the switch 53C does not connect the terminal 531 to the terminals 534 and 535 and does not connect the terminal 532 to the terminals 533 and 535.

Thus, the transmission signal of the band A received from the RFIC 3 via the radio frequency input terminal 111 is transmitted to the antenna 2a via the power amplifier 11, the filter 31, the switch 51, the switch 53C, and the antenna connection terminal 101. On the other hand, the transmission signal of the band A received from the RFIC 3 via the radio frequency input terminal 112 is transmitted to the antenna 2b via the power amplifier 12, the filter 32, the switch 52, the switch 53C, and the antenna connection terminal 102. As a result, the communication device 5C can simultaneously transmit two transmission signals (for example, uplink signals) of the band A to the outside in the second power class (for example, power class 3).

### [2.6 Effects]

As described above, the radio frequency circuit 1C according to the present modification may further include: the switch 52 that includes the terminal 521 connected to the filter 32, the terminal 522 connected to the antenna connection terminal 102, and the terminal 523 connected to the terminal 513 of the switch 51; and the switch 53C that includes the terminal 531 connected to the antenna connection terminal 101, the terminal 532 connected to the antenna connection terminal 102, the terminal 533 connected to the terminal 512 of the switch 51, the terminal 534 connected to the terminal 522 of the switch 52, and the terminal 535 connected to the terminal 513 of the switch 51 and the terminal 523 of the switch 52. The phase shifter 41 may be connected between the terminal 513 of the switch 51 and the terminal 523 of the switch 52.

With such a configuration, the radio frequency circuit 1C can disconnect the phase shifter 41 from the transmission path from the power amplifier 12 to the antenna connection terminal 102 by switching the switch 52, so that mismatching loss caused by the phase shifter 41 can be suppressed. Further, the radio frequency circuit 1C can realize antenna swapping by the switch 53C.

Further, for example, in the radio frequency circuit 1C according to the present modification, in the first communication mode in which one signal of the band A is transmitted in the first power class defined by the first maximum output power, the switch 51 may be configured to connect the terminal 511 to the terminal 513, the switch 52 may be configured to connect the terminal 521 to the terminal 523, and the switch 53C may be configured to connect the terminal 532 to the terminal 535. Further, in the second communication mode in which two signals of the band A are simultaneously transmitted in the second power class defined by the second maximum output power lower than the first maximum output power, the switch 51 may be configured to connect the terminal 511 to the terminal 512, the switch 52 may be configured to connect the terminal 521 to the terminal 522, and the switch 53C may be configured to connect the terminal 531 to the terminal 533 and connect the terminal 532 to the terminal 534.

With such a configuration, the radio frequency circuit 1C can be adapted to the high power class of the band A in the first communication mode, and can deal with simultaneous transmission of two signals of the band A in the second communication mode.

### Embodiment 3

Next, Embodiment 3 will be described. The present embodiment is mainly different from Embodiments 1 and 2 in that the radio frequency circuit includes a combiner instead of a phase shifter. The present embodiment will be described below with reference to the drawings, focusing on the points different from Embodiments 1 and 2.

The circuit configuration of a communication device 5D according to the present embodiment is the same as the circuit configuration of the communication device 5 or 5B according to Embodiment 1 or 2 except that the communication device 5D includes a radio frequency circuit 1D instead of the radio frequency circuit 1 or 1B; therefore, the circuit configuration of the radio frequency circuit 1D will be described.

### [3.1 Circuit Configuration of Radio Frequency Circuit 1D]

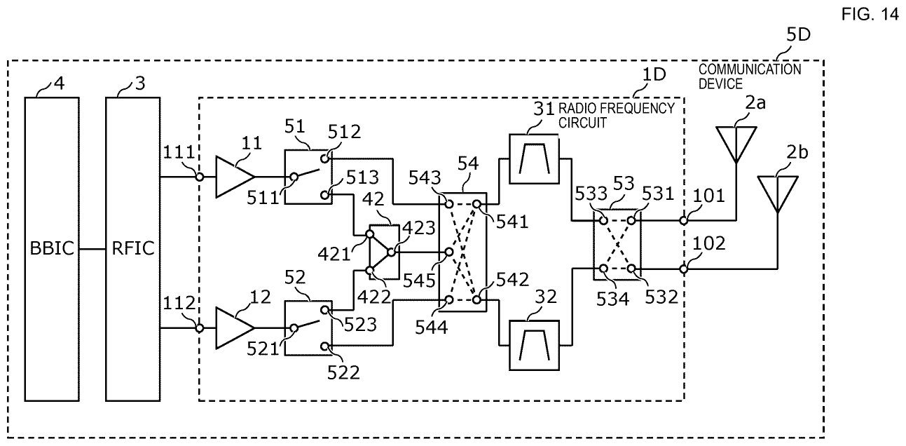

The circuit configuration of the radio frequency circuit 1D will be described with reference to FIG. 14. FIG. 14 is a circuit configuration diagram of the communication device 5D according to the present embodiment.

Note that FIG. 14 shows an exemplary circuit configuration, and the communication device 5D and the radio frequency circuit 1D may be mounted using any of a wide variety of circuit mounting and circuit techniques. Therefore, the description of the radio frequency circuit 1D provided below should not be interpreted in a limited manner.

The radio frequency circuit 1D includes power amplifiers 11 and 12, filters 31 and 32, a combiner 42, switches 51 to 54, antenna connection terminals 101 and 102, and radio frequency input terminals 111 and 112.

The power amplifier 11 is an example of the first power amplifier, and is connected so as to be switchable between the filters 31 and 32. Specifically, the input end of the power amplifier 11 is connected to the radio frequency input terminal 111. The output end of the power amplifier 11 is connected to the filters 31 and 32 with the switches 51 and 54 and, if necessary, the combiner 42 interposed therebetween.

The power amplifier 12 is an example of a second power amplifier, and is connected so as to be switchable between the filters 31 and 32. Specifically, the input end of the power amplifier 12 is connected to the radio frequency input terminal 112. The output end of the power amplifier 12 is connected to the filters 31 and 32 with the switches 52 and 54 and, if necessary, the combiner 42 interposed therebetween.

In the present embodiment, the power amplifiers 11 and 12 can constitute a differential amplifier or a balance amplifier.

The filter 31 is an example of the first filter, and is connected to the antenna connection terminal 101. Specifically, one end of the filter 31 is connected so as to be switchable between the antenna connection terminals 101 and 102 with the switch 53 interposed therebetween. The other end of the filter 31 is connected to the output end of the power amplifier 11 with the switches 54 and 51 interposed therebetween. In the present embodiment, the filter 31 is a band pass filter having a passband including the transmission band of the band A, and has an electric power handling capability corresponding to the maximum output power of the first power class.

The filter 32 is an example of the second filter, and is connected to the antenna connection terminal 102. Specifically, one end of the filter 32 is connected so as to be switchable between the antenna connection terminals 101 and 102 with the switch 53 interposed therebetween. The other end of the filter 32 is connected to the output end of the power amplifier 11 with the switch 54, the combiner 42 and the switch 51 interposed therebetween, and is connected to the output end of the power amplifier 12 with the switches 54 and 52 and, if necessary, the combiner 42 interposed therebetween. In the present embodiment, the filter 32 is a band pass filter having a passband including the transmission band of the band B, and has an electric power handling capability corresponding to the maximum output power of the first power class.

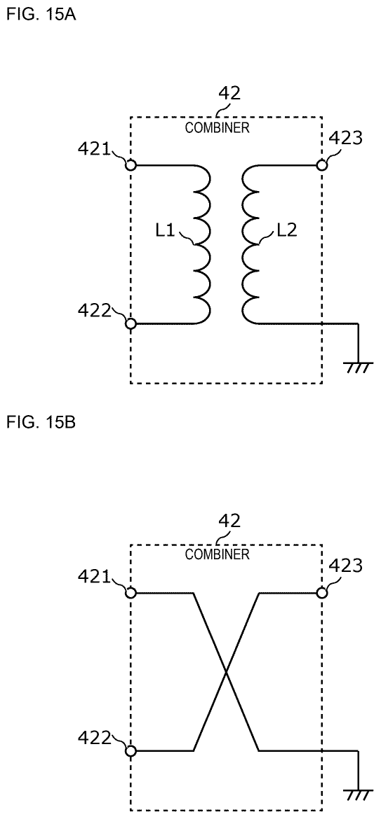

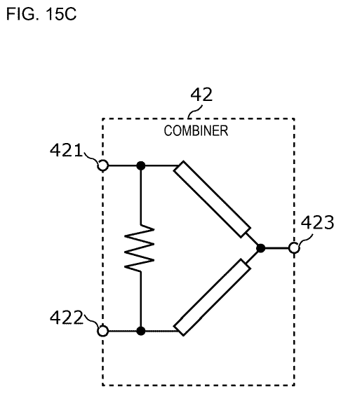

The combiner 42 includes input terminals 421 and 422 and an output terminal 423. The input terminal 421 is an example of a first input terminal, and is connected to a terminal 513 of the switch 51. The input terminal 422 is an example of a second input terminal, and is connected to a terminal 523 of the switch 52. The output terminal 423 is connected to a terminal 545 of the switch 54. The combiner 42 can combine the transmission signal of the band A or B amplified by the power amplifier 11 and the transmission signal of the band A or B amplified by the power amplifier 12. Note that the internal configuration of the combiner 42 will be described later with reference to FIGS. 15A to 15C.

The switch 51 is an example of the first switch, and includes terminals 511 and 512, and the terminal 513. The terminal 511 is an example of the first common terminal, and is connected to the output end of the power amplifier 11. The terminal 512 is an example of the first selection terminal, and is connected to the other end of the filter 31 with the switch 54 interposed therebetween. The terminal 513 is an example of the second selection terminal, and is connected to the input terminal 421 of the combiner 42.

The switch 52 is an example of the second switch, and includes terminals 521 and 522, and the terminal 523. The terminal 521 is an example of the second common terminal, and is connected to the output end of the power amplifier 12. The terminal 522 is an example of the third selection terminal, and is connected to the other end of the filter 32 with the switch 54 interposed therebetween. The terminal 523 is an example of the fourth selection terminal, and is connected to the input terminal 422 of the combiner 42.

The switch 53 is an example of the third switch, and includes terminals 531 to 534. The terminal 531 is an example of the third common terminal, and is connected to the antenna connection terminal 101. The terminal 532 is an example of the fourth common terminal, and is connected to the antenna connection terminal 102. The terminal 533 is an example of the fifth selection terminal, and is connected to one end of the filter 31. The terminal 534 is an example of the sixth selection terminal, and is connected to one end of the filter 32.

Note that the switch 53 does not have to be included in the radio frequency circuit 1D. In such a case, one end of the filter 31 may be directly connected to the antenna connection terminal 101, and one end of the filter 32 may be directly connected to the antenna connection terminal 102.

The switch 54 is an example of a fourth switch, and includes terminals 541 to 545. The terminal 541 is an example of a fifth common terminal, and is connected to the other end of the filter 31. The terminal 542 is an example of a sixth common terminal, and is connected to the other end of the filter 32. The terminal 543 is an example of the seventh selection terminal, and is connected to the terminal 512 of the switch 51. The terminal 544 is an example of an eighth selection terminal, and is connected to the terminal 522 of the switch 52. The terminal 545 is an example of a ninth selection terminal, and is connected to the output terminal 423 of the combiner 42.

In such a connection configuration, the switch 54 can exclusively connect the terminals 541 or 542 to the terminals 543 to 545 based on a control signal from the RFIC 3, for example. The switch 54 is composed of, for example, a DP3T type switch circuit.

### [3.2 Internal Configuration of Combiner 42]

Next, the internal configuration of the combiner 42 will be described with reference to FIGS. 15A to 15C. FIGS. 15A to 15C are mutually different examples of circuit configuration diagrams of the combiner 42 according to the present embodiment.

FIGS. 15A to 15C show exemplary circuit configurations, and the combiner 42 may be mounted using any of a wide variety of circuit mounting and circuit techniques. Therefore, the description of the combiner 42 provided below should not be interpreted in a limited manner.

In the example of FIG. 15A, the combiner 42 includes a balun. Specifically, the combiner 42 includes a primary coil L1 connected between the input terminals 421 and 422 and a secondary coil L2 connected between the output terminal 423 and the ground. In such an example, the combiner 42 can convert balanced signals received via the two input terminals 421 and 422 into an unbalanced signal and output the unbalanced signal via the output terminal 423.

In the example of FIG. 15B, the combiner 42 includes an orthogonal hybrid coupler. In such an example, the combiner 42 can combine two signals received via the two input terminals 421 and 422 into one signal and output the combined signal via the output terminal 423, in which the two signals received via the two input terminals 421 and 422 have a phase difference of 90 degrees from each other. Note that the type of the orthogonal hybrid coupler is not particularly limited.

In the example of FIG. 15C, the combiner 42 includes a Wilkinson coupler. In such an example, the combiner 42 can combine two in-phase signals received via the two input terminals 421 and 422 into one signal and output the combined signal via the output terminal 423. Note that the configuration of the Wilkinson coupler is not limited to that shown in FIG. 15C.

### [3.3 Communication Mode of Radio Frequency Circuit 1D]

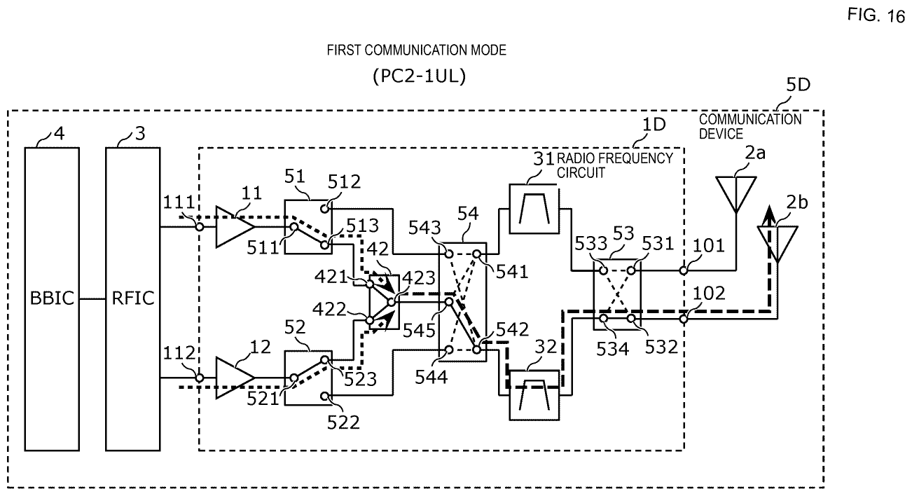

Next, a plurality of communication modes of the radio frequency circuit 1D will be described with reference to FIGS. 16 to 18. First, a first communication mode (PC2-1UL) of the radio frequency circuit 1D will be described with reference to FIG. 16. FIG. 16 is a diagram showing the first communication mode of the radio frequency circuit 1D according to the present embodiment.

In the first communication mode, the radio frequency input terminals 111 and 112 receive two identical transmission signals of the band B from the RFIC 3. At this time, the switch 51 connects the terminal 511 to the terminal 513, the switch 52 connects the terminal 521 to the terminal 523, the switch 53 connects the terminal 532 to the terminal 534, and the switch 54 connects the terminal 542 to the terminal 545. Conversely, the switch 51 does not connect the terminal 511 to the terminal 512, the switch 52 does not connect the terminal 521 to the terminal 522, the switch 53 does not connect the terminal 532 to the terminal 533, and the switch 54 does not connect the terminal 542 to the terminals 543 and 544.

Thus, the transmission signal of the band B received from the RFIC 3 via the radio frequency input terminal 111 is transmitted to the combiner 42 via the power amplifier 11 and the switch 51. Further, the transmission signal of the band B received from the RFIC 3 via the radio frequency input terminal 112 is transmitted to the combiner 42 via the power amplifier 12 and the switch 52. Further, the two transmission signals of the band B are combined into one signal by the combiner 42 and transmitted to the antenna 2b via the switch 54, the filter 32, the switch 53, and the antenna connection terminal 102. As a result, the communication device 5D can transmit one transmission signal (for example, uplink signal) of the band B to the outside in the first power class (for example, power class 2).

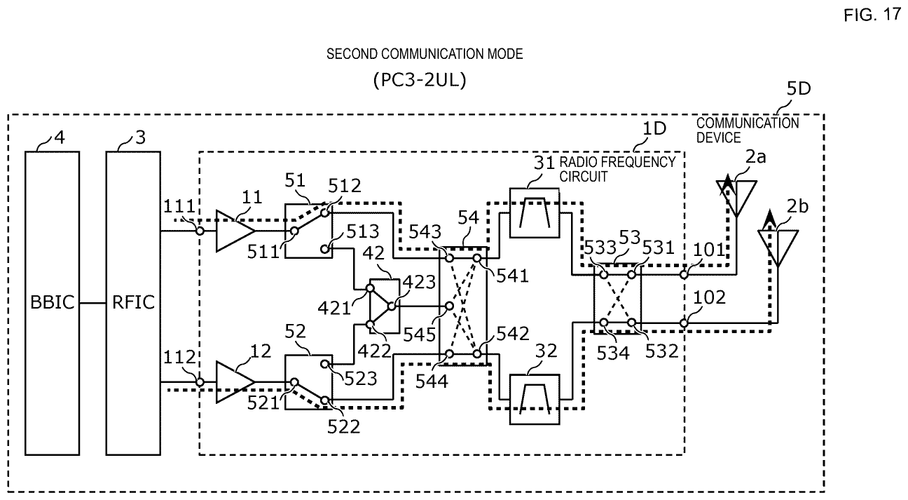

Next, a second communication mode (PC3-2UL) of the radio frequency circuit 1D will be described with reference to FIG. 17. FIG. 17 is a diagram showing the second communication mode of the radio frequency circuit 1D according to the present embodiment.

In the second communication mode, the radio frequency input terminals 111 and 112 receive two different transmission signals of the band A from the RFIC 3. At this time, the switch 51 connects the terminal 511 to the terminal 512, the switch 52 connects the terminal 521 to the terminal 522, the switch 53 connects the terminal 531 to the terminal 533 and connects the terminal 532 to the terminal 534, and the switch 54 connects the terminal 541 to the terminal 543 and connects the terminal 542 to the terminal 544. Conversely, the switch 51 does not connect the terminal 511 to the terminal 513, the switch 52 does not connect the terminal 521 to the terminal 523, the switch 53 does not connect the terminal 531 to the terminal 534 and does not connect the terminal 532 to the terminal 533, and the switch 54 does not connect the terminal 541 to the terminals 544 and 545 and does not connect the terminal 542 to the terminals 543 and 545.

Thus, the transmission signal of the band A received from the RFIC 3 via the radio frequency input terminal 111 is transmitted to the antenna 2a via the power amplifier 11, the switches 51 and 54, the filter 31, the switch 53, and the antenna connection terminal 101. On the other hand, the transmission signal of the band A received from the RFIC 3 via the radio frequency input terminal 112 is transmitted to the antenna 2b via the power amplifier 12, the switches 52 and 54, the filter 32, the switch 53, and the antenna connection terminal 102. As a result, the communication device 5D can simultaneously transmit two transmission signals (for example, uplink signals) of the band A to the outside in the second power class (for example, power class 3).

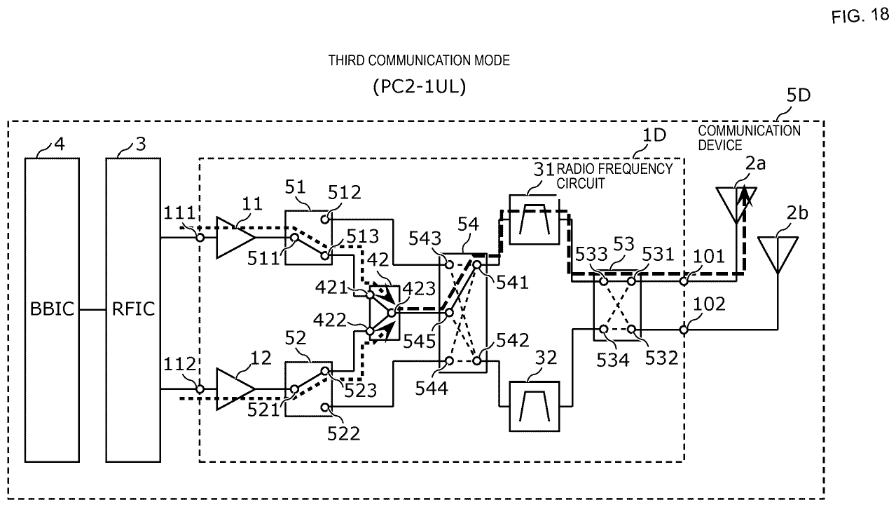

Next, a third communication mode (PC2-1UL) of the radio frequency circuit 1D will be described with reference to FIG. 18. FIG. 18 is a diagram showing the third communication mode of the radio frequency circuit 1D according to the present embodiment.

In the third communication mode, the radio frequency input terminals 111 and 112 receive two identical transmission signals of the band A from the RFIC 3. At this time, the switch 51 connects the terminal 511 to the terminal 513, the switch 52 connects the terminal 521 to the terminal 523, the switch 53 connects the terminal 531 to the terminal 533, and the switch 54 connects the terminal 541 to the terminal 545. Conversely, the switch 51 does not connect the terminal 511 to the terminal 512, the switch 52 does not connect the terminal 521 to the terminal 522, the switch 53 does not connect the terminal 531 to the terminal 534, and the switch 54 does not connect the terminal 541 to the terminals 543 and 544.

Thus, the transmission signal of the band A received from the RFIC 3 via the radio frequency input terminal 111 is transmitted to the combiner 42 via the power amplifier 11 and the switch 51. Further, the transmission signal of the band A received from the RFIC 3 via the radio frequency input terminal 112 is transmitted to the combiner 42 via the power amplifier 12 and the switch 52. Further, the two transmission signals of the band A are combined into one signal by the combiner 42 and transmitted to the antenna 2a via the switch 54, the filter 31, the switch 53, and the antenna connection terminal 101. As a result, the communication device 5D can transmit one transmission signal (for example, uplink signal) of the band A to the outside in the first power class (for example, power class 2).

### [3.4 Effects]

As described above, the radio frequency circuit 1D according to the present embodiment includes: the antenna connection terminals 101 and 102; the power amplifiers 11 and 12; the filter 31 connected between the antenna connection terminal 101 and the power amplifier 11 and having the passband including the transmission band of the band A; the filter 32 connected between the antenna connection terminal 102 and the power amplifier 12 and having the passband including the transmission band of the band B; the combiner 42 that includes input terminals 421 and 422, and the output terminal 423; the switch 51 capable of switching the connection between the power amplifier 11 and the filter 31 and the connection between the power amplifier 11 and the input terminal 421 of the combiner 42; the switch 52 capable of switching the connection between the power amplifier 12 and the filter 32 and the connection between the power amplifier 12 and the input terminal 422 of the combiner 42; and the switch 54 capable of switching the connection between the filter 31 and the switch 51, the connection between the filter 32 and the switch 52, and the connection between the filter 32 and the output terminal 423 of the combiner 42.

With such a configuration, the radio frequency circuit 1D can use the switches 51, 52 and 54 to connect the two power amplifiers 11 and 12 to the one antenna connection terminal 102 with the combiner 42 interposed therebetween. Therefore, since the two radio frequency signals amplified by the power amplifiers 11 and 12 can be combined, the amplification of radio frequency signals corresponding to the high power class can be realized while suppressing the increase in the maximum output power of each of the power amplifiers 11 and 12. Further, the radio frequency circuit 1D can use the switches 51, 52 and 54 to connect the two power amplifiers 11 and 12 individually to the two antenna connection terminals 101 and 102 with no combiner 42 interposed therebetween. Therefore, the radio frequency circuit 1D can simultaneously transmit two radio frequency signals of the bands A and B in a low power class. In other words, in the radio frequency circuit 1D adaptable to the high power class, it is possible to deal with simultaneous transmission of a plurality of radio frequency signals without increasing the number of power amplifiers. In summary, the radio frequency circuit 1D can deal with simultaneous transmission of a plurality of radio frequency signals in a frequency band to which the high power class can be applied, and further, can suppress the increase of the circuit scale of the radio frequency circuit 1D.

Further, for example, in the radio frequency circuit 1D according to the present embodiment, the combiner 42 may include a balun.

With such a configuration, the radio frequency circuit 1D can use the combiner 42 to convert balanced signals into an unbalanced signal. Therefore, the power amplifiers 11 and 12 can amplify the balanced signals and attenuate the spurious components (in particular, harmonic distortion of even order).

Further, for example, in the radio frequency circuit 1D according to the present embodiment, the combiner 42 may include an orthogonal hybrid coupler.

With such a configuration, the radio frequency circuit 1D can use the combiner 42 to combine two signals into one signal, in which the two signals have a phase difference of 90 degrees from each other. Therefore, the radio frequency circuit 1D can operate stably against load variations.

Further, for example, in the radio frequency circuit 1D according to the present embodiment, the combiner 42 may include a Wilkinson coupler.

With such a configuration, the radio frequency circuit 1D can use the combiner 42 to combine two in-phase signals into one signal.

Further, for example, in the radio frequency circuit 1D according to the present embodiment, the switch 51 may include the terminal 511 connected to the power amplifier 11, the terminal 512 connected to the switch 54, and the terminal 513 connected to the input terminal 421 of the combiner 42, the switch 52 may include the terminal 521 connected to the power amplifier 12, the terminal 522 connected to the switch 54, and the terminal 523 connected to the input terminal 422 of the combiner 42, and the switch 53 may include the terminal 541 connected to the filter 31, the terminal 542 connected to the filter 32, the terminal 543 connected to the terminal 512 of the switch 51, the terminal 544 connected to the terminal 522 of the switch 52, and the terminal 545 connected to the output terminal 423 of the combiner 42. In a first communication mode in which one signal of the band B is transmitted in a first power class defined by a first maximum output power, the switch 51 may be configured to connect the terminal 511 to the terminal 513, the switch 52 may be configured to connect the terminal 521 to the terminal 523, and the switch 54 may be configured to connect the terminal 542 to the terminal 545. In a second communication mode in which two signals of the bands A and B are simultaneously transmitted in a second power class defined by a second maximum output power lower than the first maximum output power, the switch 51 may be configured to connect the terminal 511 to the terminal 512, the switch 52 may be configured to connect the terminal 521 to the terminal 522, and the switch 54 may be configured to connect the terminal 541 to the terminal 543 and connect the terminal 542 to the terminal 544. In a third communication mode in which one signal of the band A is transmitted in the first power class, the switch 51 may be configured to connect the terminal 511 to the terminal 513, the switch 52 may be configured to connect the terminal 521 to the terminal 523, and the switch 54 may be configured to connect the terminal 541 to the terminal 545.

With such a configuration, the radio frequency circuit 1D can be adapted to the high power class of the band B in the first communication mode, can deal with simultaneous transmission of two signals of the bands A and B in the second communication mode, and can be adapted to the high power class of the band A in the third communication mode.

Further, for example, the radio frequency circuit 1D according to the present embodiment may further include the switch 53 that includes the terminal 531 connected to the antenna connection terminal 101, the terminal 532 connected to the antenna connection terminal 102, the terminal 533 connected to the filter 31, and the terminal 534 connected to the filter 32.

With such a configuration, the radio frequency circuit 1D can realize antenna swapping by the switch 53.

### Embodiment 4

Next, Embodiment 4 will be described. The present embodiment is mainly different from Embodiment 3 in that the radio frequency circuit is configured to combine the radio frequency signals after passing through the filters. The present embodiment will be described below with reference to the drawings, focusing on the points different from Embodiment 3.

The circuit configuration of a communication device 5E according to the present embodiment is the same as the circuit configuration of the communication device 5D according to Embodiment 3 except that the communication device 5E includes a radio frequency circuit 1E instead of the radio frequency circuit 1D; therefore, the circuit configuration of the radio frequency circuit 1E will be described.

### [4.1 Circuit Configuration of Radio Frequency Circuit 1E]

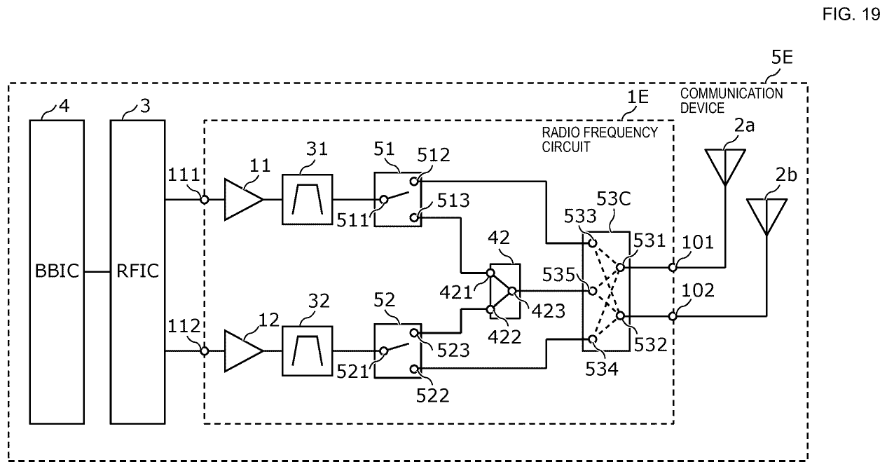

The circuit configuration of the radio frequency circuit 1E will be described with reference to FIG. 19. FIG. 19 is a circuit configuration diagram of the communication device 5E according to the present embodiment.

Note that FIG. 19 shows an exemplary circuit configuration, and the communication device 5E and the radio frequency circuit 1E may be mounted using any of a wide variety of circuit mounting and circuit techniques. Therefore, the description of the radio frequency circuit 1E provided below should not be interpreted in a limited manner.

The radio frequency circuit 1E includes power amplifiers 11 and 12, filters 31 and 32, a combiner 42, switches 51, 52 and 53C, antenna connection terminals 101 and 102, and radio frequency input terminals 111 and 112.

The power amplifier 11 is an example of the first power amplifier, and is connected to the filter 31. Specifically, the input end of the power amplifier 11 is connected to the radio frequency input terminal 111, and the output end of the power amplifier 11 is connected to the filter 31.

The power amplifier 12 is an example of the second power amplifier, and is connected to the filter 32. Specifically, the input end of the power amplifier 12 is connected to the radio frequency input terminal 112, and the output end of the power amplifier 12 is connected to the filter 32.

In the present embodiment, the power amplifiers 11 and 12 can constitute a differential amplifier or a balance amplifier in the same manner as in Embodiment 3.

The filter 31 is an example of the first filter, and is connected to the power amplifier 11. Specifically, one end of the filter 31 is connected so as to be switchable between the antenna connection terminals 101 and 102 with the switches 51 and 53C and, if necessary, the combiner 42 interposed therebetween. The other end of the filter 31 is connected to the output end of the power amplifier 11. The filter 31 is a band pass filter having a passband including the transmission band of the band A. In the present embodiment, it is sufficient that the filter 31 has an electric power handling capability corresponding to the maximum output power of the second power class, and the filter 31 does not have to have an electric power handling capability corresponding to the maximum output power of the first power class.

The filter 32 is an example of the second filter, and is connected to the power amplifier 12. Specifically, one end of the filter 32 is connected so as to be switchable between the antenna connection terminals 101 and 102 with the switches 52 and 53C and, if necessary, the combiner 42 interposed therebetween. The other end of the filter 32 is connected to the output end of the power amplifier 12. The filter 32 is a band pass filter having a passband including the transmission band of the band A. Note that, in the present embodiment, it is sufficient that the filter 32 has an electric power handling capability corresponding to the maximum output power of the second power class, and the filter 32 does not have to have an electric power handling capability corresponding to the maximum output power of the first power class.

The combiner 42 includes input terminals 421 and 422 and an output terminal 423. The input terminal 421 is an example of the first input terminal, and is connected to a terminal 513 of the switch 51. The input terminal 422 is an example of the second input terminal, and is connected to a terminal 523 of the switch 52. The output terminal 423 is connected to a terminal 535 of the switch 53C.

The switch 51 is an example of the first switch, and includes terminals 511 and 512, and the terminal 513. The terminal 511 is an example of the first common terminal, and is connected to one end of the filter 31. The terminal 512 is an example of the first selection terminal, and is connected so as to be switchable between the antenna connection terminals 101 and 102 with the switch 53C interposed therebetween. The terminal 513 is an example of the second selection terminal, and is connected to the input terminal 421 of the combiner 42.

The switch 52 is an example of the second switch, and includes terminals 521 and 522, and the terminal 523. The terminal 521 is an example of the second common terminal, and is connected to one end of the filter 32. The terminal 522 is an example of the third selection terminal, and is connected so as to be switchable between the antenna connection terminals 101 and 102 with the switch 53C interposed therebetween. The terminal 523 is an example of the fourth selection terminal, and is connected to the input terminal 422 of the combiner 42.

The switch 53C is an example of the third switch, and includes terminals 531 to 534, and the terminal 535. The terminal 531 is an example of the third common terminal, and is connected to the antenna connection terminal 101. The terminal 532 is an example of the fourth common terminal, and is connected to the antenna connection terminal 102. The terminal 533 is an example of the fifth selection terminal, and is connected to the terminal 512 of the switch 51. The terminal 534 is an example of the sixth selection terminal, and is connected to the terminal 522 of the switch 52. The terminal 535 is an example of the seventh selection terminal, and is connected to the output terminal 423 of the combiner 42.

### [4.2 Communication Mode of Radio Frequency Circuit 1E]

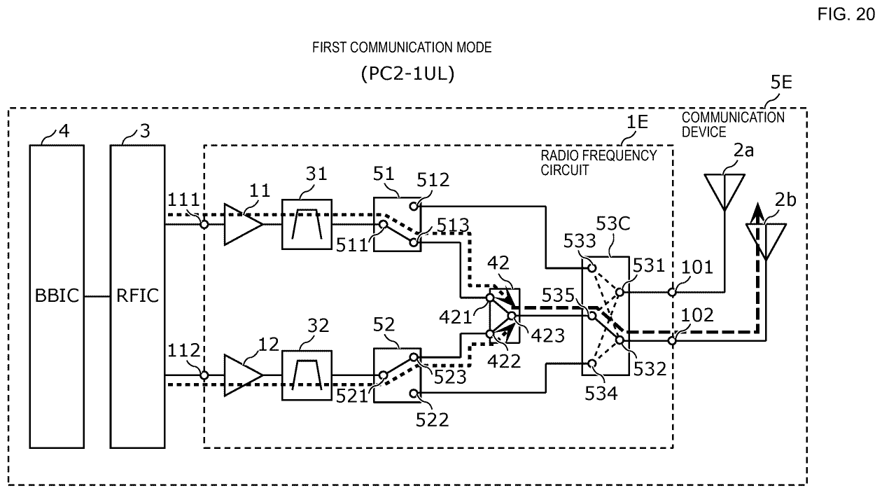

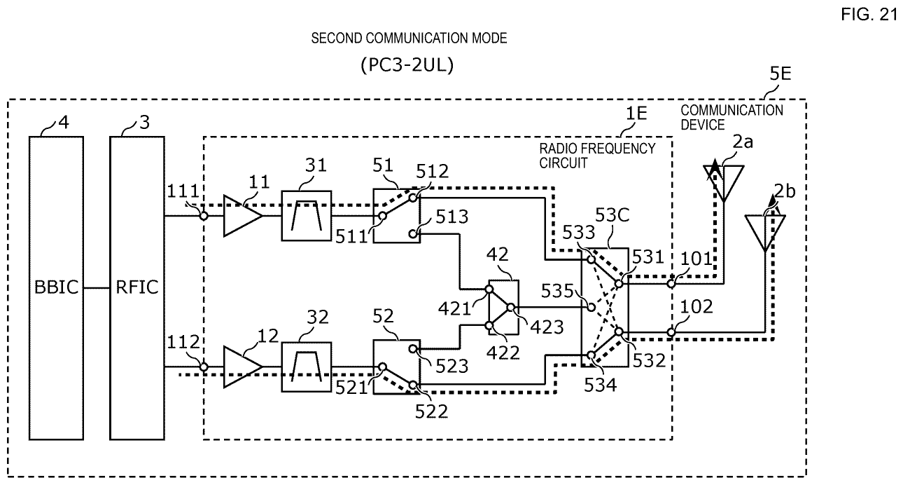

Next, a plurality of communication modes of the radio frequency circuit 1E will be described with reference to FIGS. 20 and 21. First, a first communication mode (PC2-1UL) of the radio frequency circuit 1E will be described with reference to FIG. 20. FIG. 20 is a diagram showing the first communication mode of the radio frequency circuit 1E according to the present embodiment.

In the first communication mode, the radio frequency input terminals 111 and 112 receive two identical transmission signals of the band A from the RFIC 3, in which the two identical transmission signals have a phase difference of 90 degrees or 180 degrees from each other. At this time, the switch 51 connects the terminal 511 to the terminal 513, the switch 52 connects the terminal 521 to the terminal 523, and the switch 53C connects the terminal 532 to the terminal 535. Conversely, the switch 51 does not connect the terminal 511 to the terminal 512, the switch 52 does not connect the terminal 521 to the terminal 522, and the switch 53C does not connect the terminal 532 to the terminals 533 and 534.

Thus, the transmission signal of the band A received from the RFIC 3 via the radio frequency input terminal 111 is transmitted to the combiner 42 via the power amplifier 11, the filter 31, and the switch 51. Further, the transmission signal of the band A received from the RFIC 3 via the radio frequency input terminal 112 is transmitted to the combiner 42 via the power amplifier 12, the filter 32, and the switch 52. Further, the two transmission signals of the band A are combined into one signal by the combiner 42 and transmitted to the antenna 2b via the switch 53C and the antenna connection terminal 102. As a result, the communication device 5E can transmit one transmission signal (for example, uplink signal) of the band A to the outside in the first power class (for example, power class 2).

Next, a second communication mode (PC3-2UL) of the radio frequency circuit 1E will be described with reference to FIG. 21. FIG. 21 is a diagram showing the second communication mode of the radio frequency circuit 1E according to the present embodiment.

In the second communication mode, the radio frequency input terminals 111 and 112 receive two different transmission signals of the band A from the RFIC 3. At this time, the switch 51 connects the terminal 511 to the terminal 512, the switch 52 connects the terminal 521 to the terminal 522, and the switch 53C connects the terminal 531 to the terminal 533 and connects the terminal 532 to the terminal 534. Conversely, the switch 51 does not connect the terminal 511 to the terminal 513, the switch 52 does not connect the terminal 521 to the terminal 523, and the switch 53C does not connect the terminal 531 to the terminals 534 and 535, and the terminal 532 does not connect to the terminals 533 and 535.

Thus, the transmission signal of the band A received from the RFIC 3 via the radio frequency input terminal 111 is transmitted to the antenna 2a via the power amplifier 11, the filter 31, the switches 51 and 53C, and the antenna connection terminal 101. On the other hand, the transmission signal of the band A received from the RFIC 3 via the radio frequency input terminal 112 is transmitted to the antenna 2b via the power amplifier 12, the filter 32, the switches 52 and 53C, and the antenna connection terminal 102. As a result, the communication device 5E can transmit the two transmission signals (for example, uplink signals) of the band A to the outside in the second power class (for example, power class 3).

### [4.3 Effects]

As described above, the radio frequency circuit 1E according to the present embodiment includes: the antenna connection terminals 101 and 102; the power amplifiers 11 and 12; the filter 31 connected between the antenna connection terminal 101 and the power amplifier 11 and having the passband including the transmission band of the band A; the filter 32 connected between the antenna connection terminal 102 and the power amplifier 11 and having the passband including the transmission band of the band A; the combiner 42 that includes the input terminals 421 and 422, and the output terminal 423; the switch 51 capable of switching the connection between the filter 31 and the antenna connection terminal 101 and the connection between the filter 31 and the input terminal 421 of the combiner 42; the switch 52 capable of switching the connection between the filter 32 and the antenna connection terminal 102 and the connection between the filter 32 and the input terminal 422 of the combiner 42; and the switch 53C capable of switching the connection between the antenna connection terminal 101 and the switch 51, the connection between the antenna connection terminal 102 and the switch 52, and the connection between the antenna connection terminal 102 and the output terminal 423 of the combiner 42.

With such a configuration, the radio frequency circuit 1E can use the switches 51, 52 and 53C to connect the two power amplifiers 11 and 12 to the one antenna connection terminal 102 with the combiner 42 interposed therebetween. Therefore, since the two radio frequency signals amplified by the power amplifiers 11 and 12 can be combined, the amplification of radio frequency signals corresponding to the high power class can be realized while suppressing the increase in the maximum output power of each of the power amplifiers 11 and 12. At this time, since the two radio frequency signals amplified by the power amplifiers 11 and 12 are combined after passing through the filters 31 and 32, respectively, it is possible to suppress the increase in the electric power handling capability required for the filters 31 and 32 without necessity to adapt each of the filters 31 and 32 to the high power class. Further, the radio frequency circuit 1E can use the switches 51, 52 and 53C to connect the two power amplifiers 11 and 12 individually to the two antenna connection terminals 101 and 102 with no combiner 42 interposed therebetween. Therefore, the radio frequency circuit 1E can simultaneously transmit two radio frequency signals of the same band in a low power class. In other words, in the radio frequency circuit 1E adaptable to the high power class, it is possible to deal with simultaneous transmission of a plurality of radio frequency signals without increasing the number of power amplifiers. In summary, the radio frequency circuit 1E can deal with simultaneous transmission of a plurality of radio frequency signals in a frequency band to which the high power class can be applied, and further, can suppress the increase of the circuit scale of the radio frequency circuit 1E.

Further, for example in the radio frequency circuit 1E according to the present embodiment, the combiner 42 may include a balun.

With such a configuration, the radio frequency circuit 1E can use the combiner 42 to convert balanced signals into an unbalanced signal. Therefore, the power amplifiers 11 and 12 can amplify the balanced signals and attenuate the spurious components (in particular, harmonic distortion of even order).

Further, for example in the radio frequency circuit 1E according to the present embodiment, the combiner 42 may include an orthogonal hybrid coupler.

With such a configuration, the radio frequency circuit 1E can use the combiner 42 to combine two signals into one signal, in which the two signals have a phase difference of 90 degrees from each other. Therefore, the radio frequency circuit 1E can operate stably against load variations.

Further, for example, in the radio frequency circuit 1E according to the present embodiment, the switch 51 may include the terminal 511 connected to the filter 31, the terminal 512 connected to the switch 53C, and the terminal 513 connected to the input terminal 421 of the combiner 42, the switch 52 may include the terminal 521 connected to the filter 32, the terminal 522 connected to the switch 53C, and the terminal 523 connected to the input terminal 422 of the combiner 42, and the switch 53C may include the terminal 531 connected to the antenna connection terminal 101, the terminal 532 connected to the antenna connection terminal 102, the terminal 533 connected to the terminal 512 of the switch 51, the terminal 534 connected to the terminal 522 of the switch 52, and the terminal 535 connected to the output terminal 423 of the combiner 42. In a first communication mode in which one signal of the band A is transmitted in a first power class defined by a first maximum output power, the switch 51 may be configured to connect the terminal 511 to the terminal 513, the switch 52 may be configured to connect the terminal 521 to the terminal 523, and the switch 53C may be configured to connect the terminal 532 to the terminal 535. In a second communication mode in which two signals of the band A are simultaneously transmitted in a second power class defined by a second maximum output power lower than the first maximum output power, the switch 51 may be configured to connect the terminal 511 to the terminal 512, the switch 52 may be configured to connect the terminal 521 to the terminal 522, and the switch 53C may be configured to connect the terminal 531 to the terminal 533 and connect the terminal 532 to the terminal 534.

With such a configuration, the radio frequency circuit 1E can be adapted to the high power class of the band A in the first communication mode, and can deal with simultaneous transmission of two signals of the band A in the second communication mode.

### Other Embodiments

The radio frequency circuit according to the present disclosure has been described above with reference to the embodiments; however, the radio frequency circuit according to the present disclosure is not limited to the embodiments described above. The present disclosure also includes other embodiments realized by combining any of the components in the embodiments described above, modifications obtained by applying various modifications conceived by those skilled in the art to the embodiments described above without departing from the spirit of the present disclosure, and various devices incorporating the radio frequency circuit described above.

For example, other circuit elements, wiring and/or the like may be inserted between the paths connecting each circuit element and signal path disclosed in the drawings in the circuit configuration of the radio frequency circuit according to each of the embodiments described above. For example, an impedance matching circuit may be inserted between the power amplifier and the filter. Further, for example, an impedance matching circuit may be inserted between the filter and the antenna connection terminal. The impedance matching circuit is composed of, but not particularly limited to, for example, an inductor and/or a capacitor.

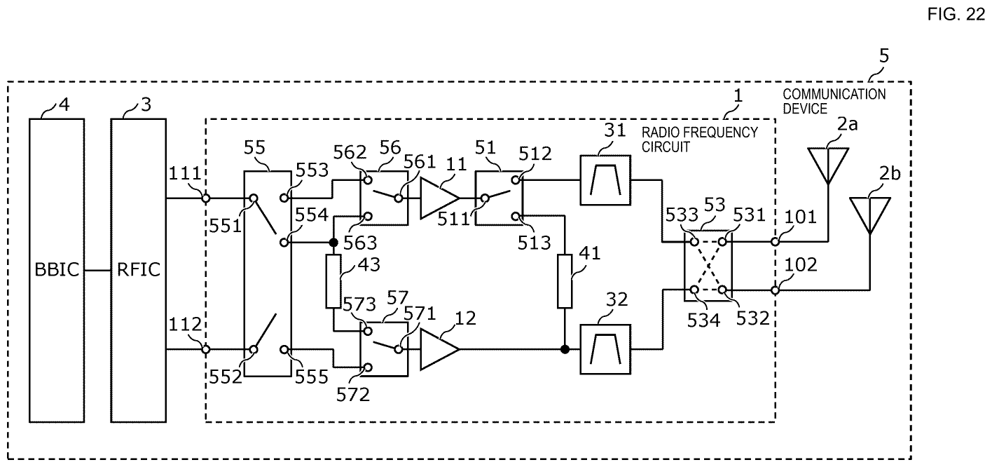

Note that, in the embodiments described above, the radio frequency circuit receives two identical transmission signals from the RFIC 3, in which the two identical transmission signals have a phase difference from each other; however, the present disclosure is not limited to such a configuration. For example, the radio frequency circuit may include an input network that distributes one signal into two identical signals having a phase difference from each other. For example, the radio frequency circuit 1 may further include an input network including switches 55 to 57 and a phase shifter 43, as shown in FIG. 22. In such a case, in the first communication mode, the switch 55 may connect a terminal 552 to a terminal 554, the switch 56 may connect a terminal 561 to a terminal 563, and the switch 57 may connect a terminal 571 to a terminal 573. At this time, the transmission signal of the band B may be supplied from the RFIC 3 only to the radio frequency input terminal 112. On the other hand, in the second communication mode, the switch 55 may connect a terminal 551 to a terminal 553 and connect the terminal 552 to a terminal 555, the switch 56 may connect the terminal 561 to a terminal 562, and the switch 57 may connect the terminal 571 to a terminal 572. At this time, the transmission signal of the band A may be supplied from the RFIC 3 to the radio frequency input terminal 111, and the transmission signal of the band B may be supplied from the RFIC 3 to the radio frequency input terminal 112. Since the illustration and description for the radio frequency circuit 1 are also applicable to the radio frequency circuits 1A to 1E, the illustration and description will not be repeated for the radio frequency circuits 1A to 1E.

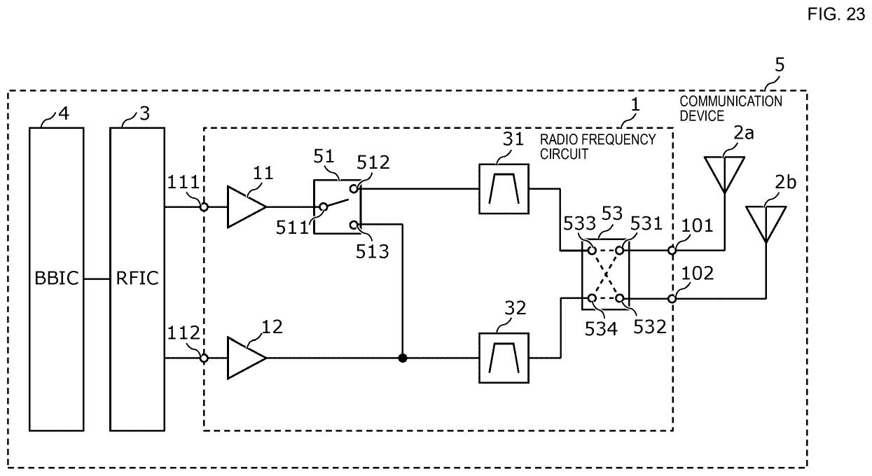

In Embodiments 1 to 4 described above, the radio frequency circuits 1 to 1C each include the phase shifter 41, but the phase shifter 41 may be omitted. For example, the radio frequency circuit 1 may be configured as shown in FIG. 23. In such a case, the power amplifiers 11 and 12 in the radio frequency circuit 1 can amplify radio frequency signals of the same phase. Since the illustration and description for the radio frequency circuit 1 are also applicable to the radio frequency circuits 1A to 1C, the illustration and description will not be repeated for the radio frequency circuits 1A to 1C.

In the embodiments described above, the radio frequency circuit includes two filters corresponding to the band A and/or the band B, but it may further include filters corresponding to other bands. At this time, one or both of the two power amplifiers may amplify signals of the other bands.

Note that, in the embodiments described above, the plurality of communication modes of the radio frequency circuit are not limited to the communication modes described above. For example, the plurality of communication modes may include a communication mode in which one transmission signal of the band A or B is transmitted in the second power class.

Note that, in the embodiments described above, the radio frequency circuit may include a reception path.

The characteristics of the radio frequency circuit described based on the above embodiments are described below.

<1>

A radio frequency circuit comprising:
a first antenna connection terminal;
a second antenna connection terminal;
a first power amplifier;
a second power amplifier;
a first filter connected between the first antenna connection terminal and the first power amplifier and having a passband including a transmission band of a first band;
a second filter connected between the second antenna connection terminal and the second power amplifier and having a passband including a transmission band of a second band; and
a first switch capable of switching a connection between the first power amplifier and the first filter and a connection between the first power amplifier and the second filter.
   <2>

The radio frequency circuit according to <1>, further comprising:
a phase shifter connected between the first switch and the second filter,
wherein
the first power amplifier and the second power amplifier constitute a Doherty amplifier,
the first power amplifier is a carrier amplifier, and
the second power amplifier is a peak amplifier.
   <3>

The radio frequency circuit according to <1> or <2>, wherein
the first switch includes a first common terminal connected to the first power amplifier, a first selection terminal connected to the first filter, and a second selection terminal connected to the second filter,
in a first communication mode in which one signal of the second band is transmitted in a first power class defined by a first maximum output power, the first switch is configured to connect the first common terminal to the second selection terminal, and
in a second communication mode in which two signals of the first band and the second band are simultaneously transmitted in a second power class defined by a second maximum output power lower than the first maximum output power, the first switch is configured to connect the first common terminal to the first selection terminal.
   <4>

The radio frequency circuit according to <3>, further comprising:
a second switch that includes a second common terminal connected to the second power amplifier, a third selection terminal connected to the second filter, and a fourth selection terminal connected to the second selection terminal of the first switch.
   <5>

The radio frequency circuit according to <4>, wherein
in the first communication mode in which one signal of the second band is transmitted in the first power class defined by the first maximum output power,
   the first switch is configured to connect the first common terminal to the second selection terminal, and
   the second switch is configured to connect the second common terminal to the third selection terminal and the fourth selection terminal,
in the second communication mode in which two signals of the first band and the second band are simultaneously transmitted in the second power class defined by the second maximum output power lower than the first maximum output power,
   the first switch is configured to connect the first common terminal to the first selection terminal, and
   the second switch is configured to connect the second common terminal to the third selection terminal,
and
in a third communication mode in which one signal of the first band is transmitted in the first power class,
   the first switch is configured to connect the first common terminal to the first selection terminal and the second selection terminal, and
   the second switch is configured to connect the second common terminal to the fourth selection terminal.
      <6>

The radio frequency circuit according to any one of <1> to <5>, further comprising:
a third switch that includes a third common terminal connected to the first antenna connection terminal, a fourth common terminal connected to the second antenna connection terminal, a fifth selection terminal connected to the first filter, and a sixth selection terminal connected to the second filter.
   <7>

A radio frequency circuit comprising:
a first antenna connection terminal;
a second antenna connection terminal;
a first power amplifier;
a second power amplifier;
a first filter connected between the first antenna connection terminal and the first power amplifier and having a passband including a transmission band of a predetermined band;
a second filter connected between the second antenna connection terminal and the second power amplifier and having a passband including a transmission band of the predetermined band; and
a first switch capable of switching a connection between the first filter and the first antenna connection terminal and a connection between the first filter and the second antenna connection terminal.
   <8>

The radio frequency circuit according to <7>, further comprising:
a phase shifter connected between the first switch and the second antenna connection terminal,
wherein
the first power amplifier and the second power amplifier constitute a Doherty amplifier,
the first power amplifier is a carrier amplifier, and
the second power amplifier is a peak amplifier.
   <9>

The radio frequency circuit according to <7> or <8>, wherein
the first switch includes a first common terminal connected to the first filter, a first selection terminal connected to the first antenna connection terminal, and a second selection terminal connected to the second antenna connection terminal,
in a first communication mode in which one signal of the predetermined band is transmitted in a first power class defined by a first maximum output power, the first switch is configured to connect the first common terminal to the second selection terminal, and
in a second communication mode in which two signals of the predetermined band are simultaneously transmitted in a second power class defined by a second maximum output power lower than the first maximum output power, the first switch is configured to connect the first common terminal to the first selection terminal.
   <10>

The radio frequency circuit according to <9>, further comprising:
a second switch that includes a second common terminal connected to the second filter, a third selection terminal connected to the second antenna connection terminal, and a fourth selection terminal connected to the second selection terminal of the first switch; and
a third switch that includes a third common terminal connected to the first antenna connection terminal, a fourth common terminal connected to the second antenna connection terminal, a fifth selection terminal connected to the first selection terminal of the first switch, a sixth selection terminal connected to the third selection terminal of the second switch, and a seventh selection terminal connected to the second selection terminal of the first switch and the fourth selection terminal of the second switch.
   <11>

The radio frequency circuit according to <10>, wherein
in the first communication mode in which one signal of the predetermined band is transmitted in the first power class defined by the first maximum output power,
   the first switch is configured to connect the first common terminal to the second selection terminal,
   the second switch is configured to connect the second common terminal to the fourth selection terminal, and
   the third switch is configured to connect the fourth common terminal to the seventh selection terminal,
and
in the second communication mode in which two signals of the predetermined band are simultaneously transmitted in the second power class defined by the second maximum output power lower than the first maximum output power,
   the first switch is configured to connect the first common terminal to the first selection terminal,
   the second switch is configured to connect the second common terminal to the third selection terminal, and
   the third switch is configured to connect the third common terminal to the fifth selection terminal and connect the fourth common terminal to the sixth selection terminal.
      <12>

A radio frequency circuit comprising:
a first antenna connection terminal;
a second antenna connection terminal;
a first power amplifier;
a second power amplifier;
a first filter having a passband including a transmission band of a predetermined band;
a second filter connected to the second antenna connection terminal and having a passband including a transmission band of the predetermined band;
a first power amplifier connected to the first filter;
a second power amplifier connected to the second filter;
a combiner including a first input terminal, a second input terminal, and an output terminal;
   a first switch capable of switching a connection between the first filter and the first antenna connection terminal and a connection between the first filter and the first input terminal of the combiner;
a second switch capable of switching a connection between the second filter and the second antenna connection terminal and a connection between the second filter and the second input terminal of the combiner; and
a third switch capable of switching a connection between the first antenna connection terminal and the first switch, a connection between the second antenna connection terminal and the second switch, and a connection between the second antenna connection terminal and the output terminal of the combiner.
   <13>

The radio frequency circuit according to <12>, wherein the combiner includes a balun.

<14>

The radio frequency circuit according to <12>, wherein the combiner includes an orthogonal hybrid coupler.

<15>

The radio frequency circuit according to <12>, wherein the combiner includes a Wilkinson coupler.

<16>

The radio frequency circuit according to any one of <12> to <15>, wherein
the first switch includes a first common terminal connected to the first filter, a first selection terminal connected to the third switch, and a second selection terminal connected to the first input terminal of the combiner,
the second switch includes a second common terminal connected to the second filter, a third selection terminal connected to the third switch, and a fourth selection terminal connected to the second input terminal of the combiner,
the third switch includes a third common terminal connected to the first antenna connection terminal, a fourth common terminal connected to the second antenna connection terminal, a fifth selection terminal connected to the first selection terminal of the first switch, a sixth selection terminal connected to the third selection terminal of the second switch, and a seventh selection terminal connected to the output terminal of the combiner,
in a first communication mode in which one signal of the predetermined band is transmitted in a first power class defined by a first maximum output power,
   the first switch is configured to connect the first common terminal to the second selection terminal,
   the second switch is configured to connect the second common terminal to the fourth selection terminal, and
   the third switch is configured to connect the fourth common terminal to the seventh selection terminal,
and
in a second communication mode in which two signals of the predetermined band are simultaneously transmitted in a second power class defined by a second maximum output power lower than the first maximum output power,
   the first switch is configured to connect the first common terminal to the first selection terminal,
   the second switch is configured to connect the second common terminal to the third selection terminal, and
   the third switch is configured to connect the third common terminal to the fifth selection terminal and connect the fourth common terminal to the sixth selection terminal.

### INDUSTRIAL APPLICABILITY

The present disclosure, as a radio frequency circuit arranged in a front-end section, can be widely used in communication apparatuses such as a mobile phone.

### REFERENCE SIGNS LIST

1, 1A, 1B, 1C, 1D, 1E radio frequency circuit
2a, 2b antenna
3 RFIC
4 BBIC
5, 5A, 5B, 5C, 5D, 5E communication device
11, 12 power amplifier
31, 32 filter
41, 43 phase shifter
42 combiner
51, 52, 53, 53C, 54, 55 switch
101, 102 antenna connection terminal
111, 112 radio frequency input terminal
421, 422 input terminal
423 output terminal
511, 512, 513, 521, 522, 523, 531, 532, 533, 534, 535, 541, 542, 543, 544, 545, 551, 552, 553 terminal
L1 primary coil
L2 secondary coil

1. A radio frequency circuit comprising:
a first antenna connection terminal;
a second antenna connection terminal;
a first power amplifier;
a second power amplifier;
a first filter coupled in a first signal path between the first antenna connection terminal and the first power amplifier, the first filter having a passband including a transmission band of a first band;
a second filter coupled in a second signal path between the second antenna connection terminal and the second power amplifier, the second filter having a passband including a transmission band of a second band; and
a first switch configured to selectively connect an output of the first power amplifier to one of the first signal path and the second signal path.

2. The radio frequency circuit according to claim 1, further comprising:
a phase shifter coupled in the second signal path between the first switch and the second filter,
wherein
the first power amplifier and the second power amplifier constitute a Doherty amplifier,
the first power amplifier is a carrier amplifier, and
the second power amplifier is a peak amplifier.

3. The radio frequency circuit according to claim 1, wherein
the first switch includes a first common terminal connected to the first power amplifier, a first selection terminal connected to the first filter, and a second selection terminal connected to the second filter,
in a first communication mode in which one signal of the second band is transmitted in a first power class defined by a first maximum output power, the first switch is configured to connect the first common terminal to the second selection terminal, and
in a second communication mode in which two signals of the first band and the second band are simultaneously transmitted in a second power class defined by a second maximum output power lower than the first maximum output power, the first switch is configured to connect the first common terminal to the first selection terminal.

4. The radio frequency circuit according to claim 3, further comprising:
a second switch that includes a second common terminal connected to the second power amplifier, a third selection terminal connected to the second filter, and a fourth selection terminal connected to the second selection terminal of the first switch.

5. The radio frequency circuit according to claim 4, wherein
in the first communication mode in which one signal of the second band is transmitted in the first power class defined by the first maximum output power,
the first switch is configured to connect the first common terminal to the second selection terminal, and
the second switch is configured to connect the second common terminal to the third selection terminal and the fourth selection terminal,
in the second communication mode in which two signals of the first band and the second band are simultaneously transmitted in the second power class defined by the second maximum output power lower than the first maximum output power,
the first switch is configured to connect the first common terminal to the first selection terminal, and
the second switch is configured to connect the second common terminal to the third selection terminal,
and
in a third communication mode in which one signal of the first band is transmitted in the first power class,
the first switch is configured to connect the first common terminal to the first selection terminal and the second selection terminal, and
the second switch is configured to connect the second common terminal to the fourth selection terminal.

6. The radio frequency circuit according to claim 1, further comprising:
a third switch configured to selectively couple the first filter to the first antenna connection terminal and the second filter to the second antenna connection terminal, and to selectively swap the connections such that the first filter is coupled to the second antenna connection terminal and the second filter is coupled to the first antenna connection terminal.

7. The radio frequency circuit according to claim 1, wherein the first band and the second band are different frequency bands.

8. The radio frequency circuit according to claim 1, wherein the first band and the second band are the same frequency bands.

9. A radio frequency circuit comprising:
a first antenna connection terminal;
a second antenna connection terminal;
a first power amplifier;
a second power amplifier;
a first filter between the first antenna connection terminal and the first power amplifier, the first filter having a passband including a transmission band of a predetermined band;
a second filter between the second antenna connection terminal and the second power amplifier, the second filter having a passband including a transmission band of the predetermined band; and
a first switch configured to selectively connect an output of the first filter and one of the first antenna connection terminal and the second antenna connection terminal.

10. The radio frequency circuit according to claim 9, further comprising:
a phase shifter between the first switch and the second antenna connection terminal,
wherein
the first power amplifier and the second power amplifier constitute a Doherty amplifier,
the first power amplifier is a carrier amplifier, and
the second power amplifier is a peak amplifier.

11. The radio frequency circuit according to claim 9, wherein
the first switch includes a first common terminal connected to the first filter, a first selection terminal connected to the first antenna connection terminal, and a second selection terminal connected to the second antenna connection terminal,
in a first communication mode in which one signal of the predetermined band is transmitted in a first power class defined by a first maximum output power, the first switch is configured to connect the first common terminal to the second selection terminal, and
in a second communication mode in which two signals of the predetermined band are simultaneously transmitted in a second power class defined by a second maximum output power lower than the first maximum output power, the first switch is configured to connect the first common terminal to the first selection terminal.

12. The radio frequency circuit according to claim 11, further comprising:
a second switch that includes a second common terminal connected to the second filter, a third selection terminal connected to the second antenna connection terminal, and a fourth selection terminal connected to the second selection terminal of the first switch; and
a third switch that includes a third common terminal connected to the first antenna connection terminal, a fourth common terminal connected to the second antenna connection terminal, a fifth selection terminal connected to the first selection terminal of the first switch, a sixth selection terminal connected to the third selection terminal of the second switch, and a seventh selection terminal connected to a node common to the second selection terminal of the first switch and the fourth selection terminal of the second switch.

13. The radio frequency circuit according to claim 12, wherein
in the first communication mode in which one signal of the predetermined band is transmitted in the first power class defined by the first maximum output power,
the first switch is configured to connect the first common terminal to the second selection terminal,
the second switch is configured to connect the second common terminal to the fourth selection terminal, and
the third switch is configured to connect the fourth common terminal to the seventh selection terminal,
and
in the second communication mode in which two signals of the predetermined band are simultaneously transmitted in the second power class defined by the second maximum output power lower than the first maximum output power,
the first switch is configured to connect the first common terminal to the first selection terminal,
the second switch is configured to connect the second common terminal to the third selection terminal, and
the third switch is configured to connect the third common terminal to the fifth selection terminal and connect the fourth common terminal to the sixth selection terminal.

14. A radio frequency circuit comprising:
a first antenna connection terminal;
a second antenna connection terminal;
a first power amplifier;
a second power amplifier;
a first filter between the first antenna connection terminal and the first power amplifier, the first filter having a passband including a transmission band of a predetermined band;
a second filter between the second antenna connection terminal and the second power amplifier, the second filter having a passband including a transmission band of the predetermined band;
a combiner that includes a first input terminal, a second input terminal, and an output terminal;
a first switch configured to selectively connect an output of the first filter to one of the first antenna connection terminal and the first input terminal of the combiner; and
a second switch configured to selectively connect an output of the second filter to one of the second antenna connection terminal and the second input terminal of the combiner.

15. The radio frequency circuit according to claim 14, further comprising:
a third switch configured to selectively route signals between the first antenna, the first switch, the second switch, the second antenna connection terminal, and the output terminal of the combiner.

16. The radio frequency circuit according to claim 14, wherein the combiner includes a balun.

17. The radio frequency circuit according to claim 14, wherein the combiner includes an orthogonal hybrid coupler.

18. The radio frequency circuit according to claim 14, wherein the combiner includes a Wilkinson coupler.

19. The radio frequency circuit according to claim 15, wherein
in a first communication mode in which one signal of the predetermined band is transmitted in a first power class defined by a first maximum output power,
the first switch is configured to connect the output of the first filter to the first input terminal of the combiner,
the second switch is configured to connect the output of the second filter to the second input terminal of the combiner, and
the third switch is configured to connect the output of the combiner to one of the first or second antenna connection terminals,
and
in a second communication mode in which two signals of the predetermined band are simultaneously transmitted in a second power class defined by a second maximum output power lower than the first maximum output power,
the first switch is configured to connect the output of first filter to the first antenna connection terminal via the third switch,
the second switch is configured to connect the output of the second filter to the second antenna connection terminal via the third switch.

20. The radio frequency circuit according to claim 14, wherein the first power amplifier and the second power amplifier constitute one of a differential amplifier or a balance amplifier.
